(19) United States
(12) Patent Application Publication
(10) Pub. No.: US 2016/0299739 A1
(43) Pub. Date: Oct. 13, 2016

(54) METHOD FOR CONTROLLING DATA STREAMING USING BLUETOOTH COMMUNICATION

(71) Applicant: LG ELECTRONICS INC., Seoul (KR)

(72) Inventor: Jonghun SONG, Seoul (KR)

(21) Appl. No.: 15/096,808

(22) Filed: Apr. 12, 2016

Related U.S. Application Data
(60) Provisional application No. 62/146,928, filed on Apr. 13, 2015.

(51) Int. Cl. G06F 3/16; H04R 3/00; H04W 4/00

(52) U.S. Cl. CPC G06F 3/165; H04W 4/008; H04R 3/00; H04R 2420/07; H04R 2430/01

(57) ABSTRACT

Disclosed herein is a remote mute method of audio streaming using Bluetooth communication. More specifically, a method for controlling the transmission and reception of audio streams in a wireless communication system supporting Bluetooth communication includes transmitting, by a first device, audio streaming to a second device or receiving audio streaming from the second device, transmitting, by the first device, a remote mute command for stopping the transmission or reception of the audio streaming to the second device during the transmission or reception of the audio streaming, and removing, by the first device, a channel used for the transmission or reception of the audio streaming.

### CROSS-REFERENCE TO RELATED APPLICATION

This non-provisional application claims the benefit under 35 U.S.C. §119(e) to U.S. Provisional Application No. 62/146,928 filed on Apr. 13, 2015 all of which are hereby expressly incorporated by reference into the present application.

### BACKGROUND OF THE INVENTION

1. Field of the Invention

The present invention relates to a method for controlling data streaming using Bluetooth communication and, more particularly, to a remote mute method and remote un-mute method of data streaming using a remote mute function.

2. Discussion of the Related Art

Bluetooth is one of representative short-distance radio technologies in which various devices, such as a smart phone, a Personal Computer (PC), an earphone, and a headphone, are interconnected and exchange information. Furthermore, Bluetooth is applied to most of smart phones, PCs, and notebooks and is easily used by many people. An easy pairing procedure stably provides connectivity between devices. A recently developed Low Energy (LE) technology can stably provide information of several hundreds of KB while consuming less power.

The core specification of a Bluetooth standard technology is divided into a Basic Rate/Enhanced Data Rate (BR/EDR) and LE.

Bluetooth Low Energy (hereinafter referred to as “BLE”) of the technologies was disclosed since Bluetooth Specification V4.0 and designed to provide higher energy efficiency than existing Bluetooth.

### SUMMARY OF THE INVENTION

An existing mute function is used to simply turn on/off only the output of a speaker in a local system and does not perform control of the transmission and reception of audio streaming. Accordingly, even after the mute function is executed, data continues to be transmitted and received. As a result, there is a problem in that unnecessary power is consumed.

An embodiment of the present invention proposes a method for stopping the transmission or reception of audio streaming using a remote mute function.

An embodiment of the present invention proposes a method for removing a channel used for the transmission and reception of audio streaming using a remote mute function.

Furthermore, an embodiment of the present invention proposes a remote mute and un-mute method using a remote controller.

Technical objects to be achieved by the present invention are not limited to the above-described objects and other technical objects that have not been described will be evidently understood by those skilled in the art from the following description.

In an embodiment of the present invention, there is proposed a method for controlling the transmission and reception of audio streams in a wireless communication system supporting Bluetooth communication, including receiving, by a first device, an audio stream from a second device through an isochronous channel, transmitting, by the first device, a remote mute command for stopping the transmission of the audio stream to the second device through an Asynchronous Connection Logical transport (ACL) channel, and removing, by the first device, the isochronous channel.

The method may further include transmitting, by the first device, a remote un-mute command for resuming the reception of the stopped audio stream to the second device and setting up, by the first device, the removed isochronous channel with the second device.

The remote mute command may be transmitted to the first device when a remote mute is performed by the second device.

The isochronous channel and the ACL channel may be different channels.

The method may further include transmitting, by the first device, information related to a call setup to the second device. The remote mute may be performed based on the information related to the call setup.

The remote mute may be performed when an in-band ring tone is not used.

Furthermore, in an embodiment of the present invention, there is provided a method for controlling the transmission and reception of audio streams in a wireless communication system supporting Bluetooth communication, including transmitting, by a first device, an audio stream to a second device through an isochronous channel, receiving, by the first device, a remote mute command for stopping the reception of the audio stream from the second device or a third device through an Asynchronous Connection Logical transport (ACL) channel, and removing, by the first device, the isochronous channel.

The method may further include receiving, by the first device, a remote un-mute command for resuming the transmission of the stopped audio stream from the second device or the third device and setting up, by the first device, the removed isochronous channel with the second device.

The isochronous channel and the ACL channel may be different channels.

The method may further include receiving, by the first device, information related to a call setup from the second device or the third device. The remote mute may be performed based on the information related to the call setup.

The remote mute may be performed when an in-band ring tone is not used.

Furthermore, in an embodiment of the present invention, there is provided a method for controlling the transmission and reception of audio streams in a wireless communication system supporting Bluetooth communication, including transmitting and receiving, by a first device, audio streams to and from the second device through an isochronous channel, transmitting, by the first device, a remote mute command for stopping the transmission of the audio stream to the second device through an Asynchronous Connection Logical transport (ACL) channel, and removing, by the first device, an isochronous channel used for the transmission of the audio stream. The isochronous channel used for the reception of the audio stream is maintained.

The method may further include transmitting, by the first device, a remote un-mute command for resuming the transmission of the stopped audio stream to the second device and setting up, by the first device, the removed isochronous channel with the second device.

The remote mute command may be transmitted to the first device when the remote mute is performed by the second device.

The isochronous channel and the ACL channel may be different channels.

The method may further include transmitting, by the first device, information related to the call setup to the second device. The remote mute may be performed based on the information related to the call setup.

The remote mute may be performed when an in-band ring tone is not used.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

FIG. 1 is a schematic diagram showing an example of a wireless communication system using a Bluetooth low energy technique proposed in this specification.

FIG. 2 shows an example of an internal block diagram of a source device and a sink device in which methods proposed in this specification may be implemented.

FIG. 3 shows an example of a Bluetooth low energy topology.

FIGS. 4 and 5 are diagrams showing examples of a Bluetooth communication architecture to which methods proposed in this specification may be applied.

FIG. 6 is a flowchart illustrating an example of a method for providing an object transfer service in a BLE technology.

FIG. 7 is a diagram showing the characteristics of an audio signal.

FIG. 8 is a diagram showing an example of a home ecosystem for applications in which an isochronous channel proposed in this specification may be used.

FIG. 9 is a diagram showing an example in which an isochronous channel proposed in this specification may be used.

FIG. 10 is a diagram showing an example of an operating state transition procedure in the BLE technology which is proposed in this specification.

FIG. 11 is a diagram illustrating problems of a mute function used in an existing Bluetooth system.

FIG. 12 is a diagram showing an example of a remote mute method of audio streaming in accordance with an embodiment to which the present invention may be applied.

FIG. 13 is a diagram showing another example of a remote mute method of audio streaming using a remote controller in accordance with an embodiment to which the present invention may be applied.

FIG. 14 is a diagram showing an example of a remote mute method and remote un-mute method of audio streaming according to an embodiment of the present invention.

FIGS. 15 and 16 are diagrams showing various examples of a remote mute method and remote un-mute method of audio streaming using a remote controller according to embodiments of the present invention.

FIGS. 17 and 18 are flowcharts illustrating examples of a remote mute method of audio streaming according to embodiments of the present invention.

FIG. 19 is a diagram showing an example of a remote mute method and remote un-mute method of audio streaming according to an embodiment of the present invention.

FIG. 20 is a diagram showing an example of a remote mute method and remote un-mute method of audio streaming in a bi-directional audio streaming environment according to an embodiment of the present invention.

FIG. 21 is a diagram showing another example of a remote mute method and remote un-mute method of audio streaming in a bi-directional audio streaming environment according to an embodiment of the present invention.

FIG. 22 is a flowchart illustrating an example of a remote mute method of audio streaming according to an embodiment of the present invention.

FIG. 23 is an example of a schematic block diagram of a remote controller capable of implementing methods proposed in this specification.

### DETAILED DESCRIPTION OF THE EMBODIMENTS

Hereinafter, some embodiments of the present invention are described in detail with reference to the accompanying drawings. The detailed description to be disclosed herein along with the accompanying drawings is provided to describe exemplary embodiments of the present invention and is not intended to describe a sole embodiment in which the present invention may be implemented. The following detailed description includes detailed contents in order to provide complete understanding of the present invention. However, those skilled in the art will appreciate that the present invention may be implemented even without such detailed contents.

In some cases, in order to avoid making the concept of the present invention vague, the known structure and/or device may be omitted or may be illustrated in the form of a block diagram based on the core function of each structure and/or device.

Furthermore, specific terms used in the following description are provided to help understanding of the present invention, and such specific terms may be changed into other forms without departing from the technical spirit of the present invention. For example, the suffixes of elements used in the following description, such as a “module” and a “unit”, are assigned by taking into consideration only the ease of writing this specification and may be interchangeably used.

A device described in this specification is capable of wireless communication and may include a mobile phone including a smart phone, a tablet PC, a desktop PC, a notebook, and TV including smart TV and IPTV.

Furthermore, although embodiments of the present invention are described in detail with reference to the accompanying drawings and contents described in the drawings, the present invention is not limited or restricted by the embodiments.

Terms used in this specification are common terms which are now widely used by taking into consideration functions in the present invention, but the terms may be changed depending on intentions of those skilled in the art, a use practice, or the appearance of a new technology.

Furthermore, terms used in this specification are common terms now widely used, but in special cases, terms randomly selected by the applicant are used. In this case, the meaning of a corresponding term is clearly described in the detailed description of a corresponding part. Accordingly, it is to be noted that the meaning of a corresponding term should not be simply construed as being based on only the name of the corresponding term used in a corresponding description of this specification, but should be construed by checking even the meaning of the corresponding term.

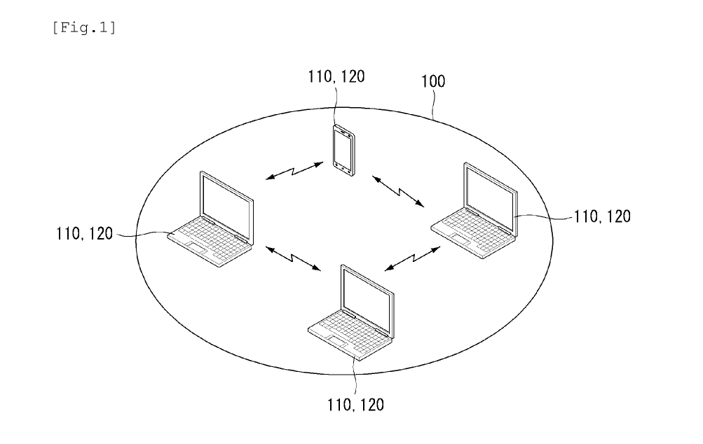

FIG. 1 is a schematic diagram showing an example of a wireless communication system using a Bluetooth low energy technique proposed in this specification.

The wireless communication system 100 includes at least one server device 110 and at least one client device 120.

The server device and the client device perform Bluetooth communication using the Bluetooth low energy (BLE) technology.

First, compared to the Bluetooth basic rate/enhanced data rate (BR/EDR) technology, the BLE technology has a relatively small duty cycle, may be cheaply fabricated, and may operate for 1 year or more if a coin cell battery is used because it can greatly reduce power consumption through a low-speed data transfer rate.

Furthermore, in the BLE technology, a connection procedure between devices has been simplified, and a packet size is smaller than that of the Bluetooth BR/EDR technology.

In the BLE technology, (1) the number of RF channels is 40, (2) a data transfer rate of 1 Mbps is supported, (3) topology is a star architecture, (4) latency is 3 ms, (5) a maximum current is 15 mA or less, (6) output power is 10 mW (10 dBm) or less, and (7) the BLE technology is chiefly used in applications, such as mobile phones, watches, sports, health care, sensors, and device control.

The server device 110 may operate as a client device in the relationship with another device. The client device may operate as a server device in the relationship with another device. That is, in a BLE communication system, any one device may operate as a server device or client device and may operate as both a server device and a client device, if necessary.

The server device 110 may be represented as a data service device, a master device, a master, a server, a conductor, a host device, an audio source device, or a first device. The client device may be represented as a slave device, a slave, a client, a member, a sink device, an audio sink device, or a second device.

The server device and the client device correspond to major elements of the wireless communication system. The wireless communication system may include other elements in addition to the server device and the client device.

The server device refers to a device which is provided with data from the client device and provided with data from the client device through a response when a request for the data is received from the client device by directly communicating with the client device.

Furthermore, the server device sends a notification message and/or an indication message to the client device in order to provide the client device with data (or information). Furthermore, when the server device is to send an indication message to the client device, it receives a confirm message corresponding to the indication message from the client device.

Furthermore, in a process of sending and receiving notification, indication, and confirm messages to and from the client device, the server device may provide a user with data (or information) through a display unit or may receive a request inputted by a user through a user input interface.

Furthermore, in a process of sending and receiving messages to and from the client device, the server device may read data from a memory unit or may write new data in the memory unit.

Furthermore, a single server device may be connected to a plurality of client devices and may be easily connected to client devices again using bonding information.

The client device 120 refers to a device which requests the server device to send data (or information).

The client device receives data from the server device through a notification message and/or an indication message and sends a confirm message in response to an indication message when the indication message is received from the server device.

Like the server device, in a process of sending and receiving messages to and from the server device, the client device may provide a user with information through a display unit or may receive input from a user through a user input interface.

Furthermore, in a process of sending and receiving messages to and from the server device, the client device may read data from a memory unit or may write data new data in the memory unit.

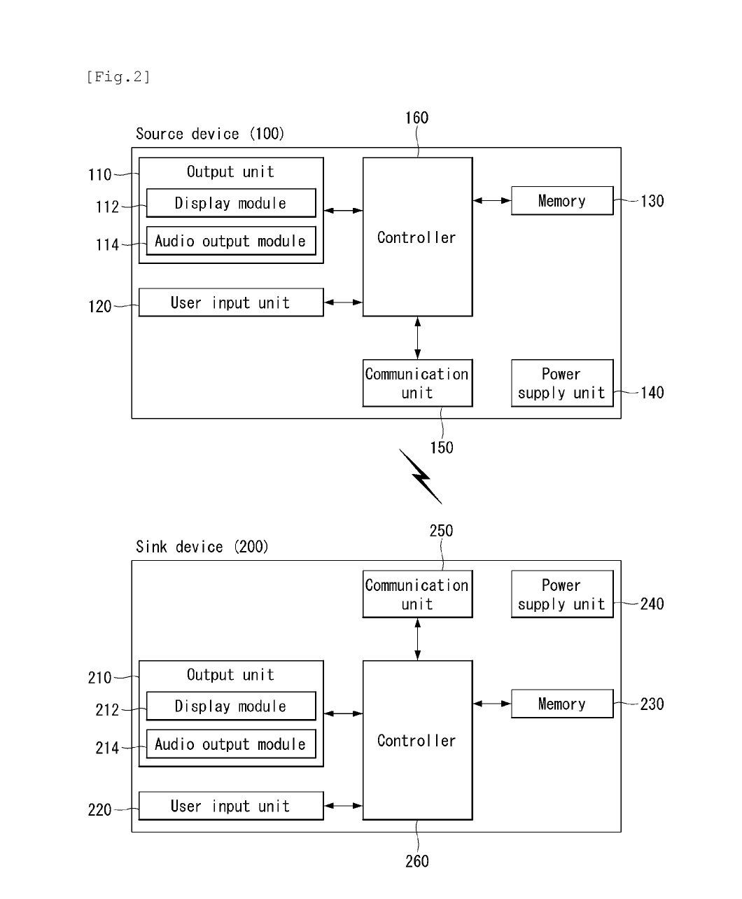

Hardware elements, such as the display unit, user input interface, and memory unit of the server device and the client device, are described in detail with reference to FIG. 2.

Furthermore, the wireless communication system may configure a personal area network (PAN) through the Bluetooth technology. For example, in the wireless communication system, files and document can be exchanged rapidly and safely by establishing a private piconet between devices.

A BLE device (or apparatus) may operate so that it supports various Bluetooth-related protocols, profiles, and processing.

FIG. 2 shows an example of an internal block diagram of a source device and a sink device in which methods proposed in this specification may be implemented.

A source device (SRC) may refer to all of electronic devices capable of storing multimedia data, such as audio/video, and transmitting the multimedia data.

A sink device (SNK) may refer to all of electronic devices capable of receiving multimedia data, such as audio/video, and outputting (or playing back) the multimedia data.

The source device or the sink device may be defined as a controller (CT) or a target (TG) depending on its function and utilization.

In this case, the controller refers to a device initiating a transaction by transmitting a command frame to a target. The controller may be a personal computer, a PDA, a mobile phone, a remote controller, or an AV device (e.g., a car system, a headphone, a Hearing Aid (HA), a player/recorder, a timer, a tuner, and a monitor).

Furthermore, the target refers to a device for receiving a command frame and transmitting a response frame in response thereto. The target may be an audio player/recorder, a video, a player/recorder, TV, a tuner, an amplifier, or a headphone.

Furthermore, the source device or the sink device may be defined as an initiator (INT) or an acceptor (ACP) in a specific procedure.

An initiator may refer to a device for initiating a procedure by transmitting a specific message, and an acceptor may refer to a device for receiving the specific message.

The source device and the sink device may include output units 110 and 210, user interface units 120 and 220, memory 130 and 230, power supplies 140 and 240, communication units 150 and 250, and control units (or processors) 160 and 260, respectively.

The output unit, the user interface unit, the memory, the power supply, the communication unit, and the control unit are operatively connected in order to perform a method proposed according to an embodiment of the present invention.

The elements of FIG. 2 are not essential, and an electronic device having elements greater than or less than the elements of FIG. 2 may be implemented.

The output units 110 and 210 function to generate output related to a visual, auditory, or tactile sense and include display modules 112 and 212 and audio output modules 114 and 214, respectively.

The display module 112, 212 displays and outputs information processed by a device. For example, if the device is call mode, the display module displays a User Interface (UI) or a Graphic User Interface (GUI) related to a call. If the device is video telephony mode or capturing mode, the display module displays a captured or/and received image, a UI, or a GUI.

The audio output module 114, 214 may output audio data received from the communication unit 150, 250 or stored in the memory 130, 230 in incoming call mode, call mode, recording mode, voice recognition mode, and broadcast reception mode. The audio output module 114, 214 outputs a sound signal related to a function (e.g., a received call sound or a received message sound) performed in the device. The audio output module 114, 214 may include a receiver, a speaker, and a buzzer.

The sink device 200 may receive multimedia content from the source device 100 through the output unit 110, 210 and output the received multimedia content in a wireless streaming manner through the output unit 110, 210.

The user input unit 120, 220 allows a user to generate input data for controlling the operation of a device. The user input unit 120, 220 may include a key pad, a dome switch, a touch pad (resistive/capacitive), a jog wheel, and a jog switch.

The memory 130, 230 may store a program for the operation of the control unit 160, 260 and temporarily store inputted/output data. The memory 130, 230 may store data regarding vibrations and sounds having various patterns, which are output when a touch on the touch screen is inputted.

The source device 100 may store multimedia content in the memory 130, may output the multimedia content through the output unit 110 of the source device 100, and may output the multimedia content through the output unit 210 of the sink device 200 using a wireless streaming method.

The power supply 140, 240 refers to a module for receiving external and external power and supplying power for the operations of the elements under the control of the control unit 160, 260.

The communication unit 160, 260 may include one or more modules that enable wireless communication between a device and a wireless communication system or between a device and a network in which a device is placed. For example, the communication unit 160, 260 may include a broadcast reception nodule (not shown), a mobile communication module (not shown), a wireless Internet module (not shown), and a short-distance communication module (not shown).

The communication unit 160, 260 may also be called a transmission/reception unit.

The short-distance communication module refers to a module for short-distance communication. Bluetooth, radio frequency identification (RFID), infrared data association (IrDA), ultra wideband (UWB), and ZigBee may be used as short-distance communication technologies.

The source device 100 and the sink device 200 may exchange data using Bluetooth and output multimedia content using a wireless streaming method.

The control unit 160, 260 refers to a module for controlling an overall operation of the source device 100 or the sink device 200 and may perform control so that a request to transmit a message and a received message are processed through a Bluetooth interface and another communication interface.

The control unit 160, 260 may also be called a controller, a microcontroller, or a microprocessor. The control unit 160, 260 may be implemented in hardware, firmware, software or a combination of them.

The control unit 160, 260 may include Application-Specific Integrated Circuits (ASICs), other chipsets, logic circuits and/or data processors.

As described above, the BLE technology has a small duty cycle and can greatly reduce power consumption through a low-speed data transfer rate. Accordingly, the power supply can supply power for the operations of the elements even using low output power (e.g., 10 mW (10 dBm) or less).

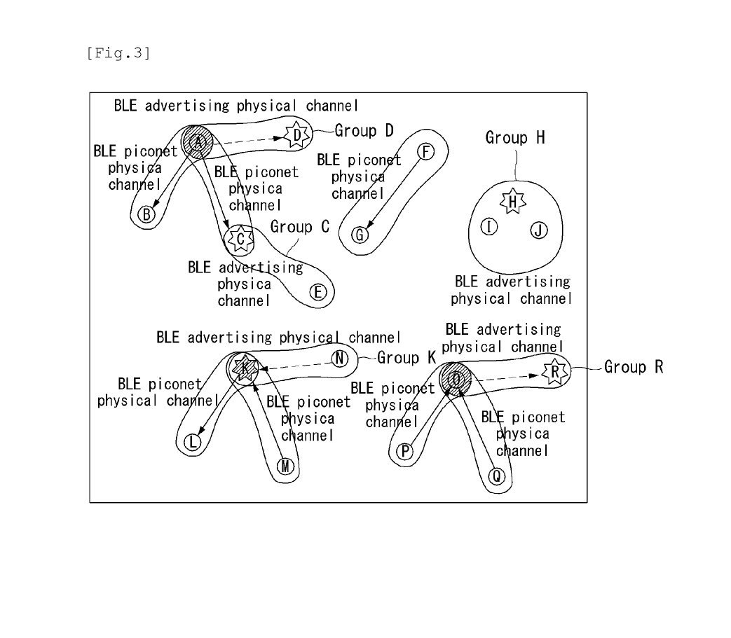

FIG. 3 shows an example of a Bluetooth low energy topology.

Referring to FIG. 3, a device A corresponds to a master in a piconet A (indicated by a shadow part) including a device B and a device C as slaves.

In this case, the piconet means a set of devices which occupy a shared physical channel, wherein any one of a plurality of the devices is a master and the remaining devices are connected to the master device.

A BLE slave does not share a common physical channel with a master. Each slave communicates with the master through a separate physical channel. There is another piconet F including a master device F and a slave device G.

A device K is present in a scatternet K. In this case, the scatternet means a group of piconets having connection between different piconets.

The device K is the master of a device L and is also the slave of a device M.

A device O is also present in a scatternet O. The device O is the slave of a device P and the slave of the device Q.

As shown in FIG. 3, 5 different device groups are present.

A device D is an advertiser, and the device A is an initiator (a group D).

A device E is a scanner, and the device C is an advertiser (a group C).

A device H is an advertiser, and devices I and J are scanners (a group H).

The device K is an advertiser, and a device N is an initiator (a group K).

A device R is an advertiser, and the device O is an initiator (a group R).

The devices A and B use one BLE piconet physical channel.

The devices A and C use different BLE piconet physical channels.

In the group D, the device D performs advertising using an advertising event which may be connected on an advertising physical channel, and the device A is an initiator. The device A may form connection with the device D and may add a device to the piconet A.

In the group C, the device C performs advertising on an advertising physical channel using any type of an advertising event captured by the scanner device E.

In order to avoid a collision, the group D and the group C may use different advertising physical channels or different times.

One physical channel is present in the piconet F. The devices F and G use one BLE piconet physical channel. The device F is a master, and the device G is a slave.

One physical channel is present in the group H. The devices H, I, and J use one BLE advertising physical channel. The device H is an advertiser, and the devices I and J are scanners.

In the scatternet K, the devices K and L use one BLE piconet physical channel. The devices K and M use different BLE piconet physical channels.

In the group K, the device K performs advertising using an advertising event which may be connected on an advertising physical channel, and the device N is an initiator. The device N may form connection with the device K. In this case, the device K is a slave of two devices and is also a master of any one device.

In the scatternet O, the devices O and P use one BLE piconet physical channel. The devices O and Q use different BLE piconet physical channels.

In the group R, the device R performs advertising using an advertising event which may be connected on an advertising physical channel, and the device O is an initiator. The device O may form connection with the device R. In this case, the device O is a slave of two devices and is also a master of any one device.

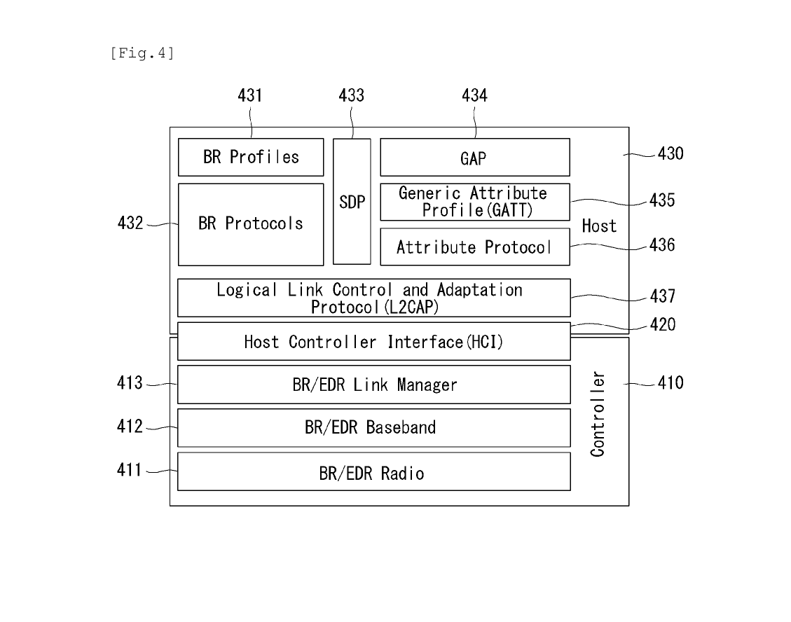

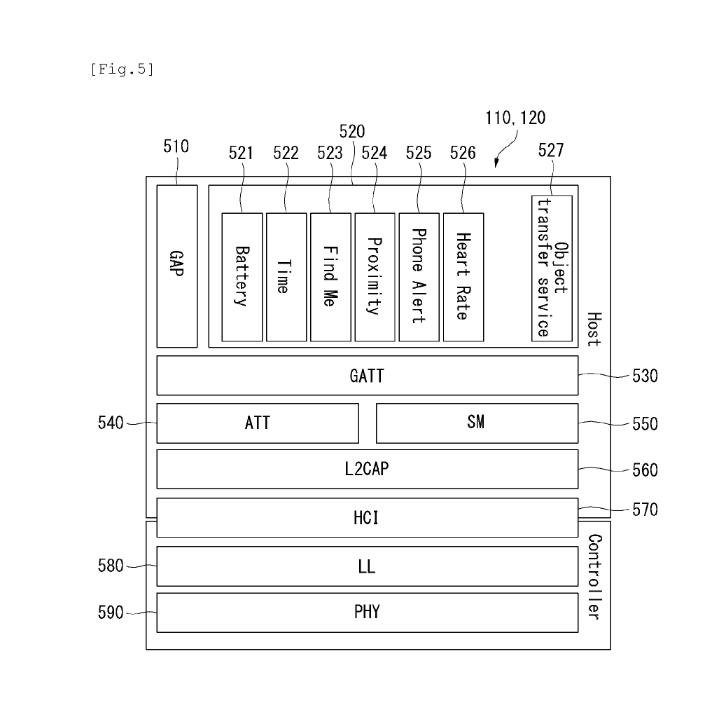

FIGS. 4 and 5 are diagrams showing examples of a Bluetooth communication architecture to which methods proposed in this specification may be applied.

More specifically, FIG. 4 shows an example of a Bluetooth basic rate/enhanced data rate (BR/EDR) architecture, and FIG. 5 shows an example of Bluetooth low energy (LE) architecture.

First, as shown in FIG. 4, the Bluetooth BR/EDR architecture includes a controller stack 410, a host controller interface (HCI) 420, and a host stack 430.

The controller stack (or controller module) 410 refers to hardware for sending or receiving a Bluetooth packet to or from a wireless transmission/reception module for receiving a Bluetooth signal of 2.4 GHz. The controller stack 410 may include a BR/EDR Radio layer 411, a BR/EDR baseband layer 412, and a BR/EDR link manager layer 413.

The BR/EDR radio layer 411 is a layer for sending and receiving a radio signal of 2.4 GHz and may send data by hopping 79 RF channels if Gaussian frequency shift keying (GFSK) modulation is used.

The BR/EDR baseband layer 412 functions to send a digital signal, selects a channel sequence for 1600 hopping per second, and sends a time slot of 625 us in length for each channel.

The link manager layer 413 controls an overall operation (e.g., link setup, control, and security) for Bluetooth connection using a link manager protocol (LMP).

The link manager layer may perform the following functions.
Perform ACL/SCO logical transport and logical link setup and control.
Detach: stop connection and notify a counterpart device of a reason for stop.
Perform power control and role switch.
Perform a security (e.g., authentication, pairing, and encryption) function.

The controller interface layer 420 provides an interface between the host module 430 and the controller module 410 so that the host provides commands and data to the controller and the controller provides events and data to the host.

The host stack (or host module) 430 includes a logical link control and adaptation protocol (L2CAP) 437, a service discovery protocol (SDP) 433, BR/EDR protocols 432, BR/EDR profiles 431, an attribute protocol 436, a generic access profile (GAP) 434, and a generic attribute profile (GATT) 435.

The L2CAP 437 provides a specific protocol or profile with one bidirectional channel for sending data.

The L2CAP multiplexes various protocols and profiles provided by the upper layer of Bluetooth.

A dynamic channel is used in the L2CAP of the Bluetooth BR/EDR. The L2CAP supports a protocol service multiplexer, retransmission mode, and streaming mode and provides segmentation and reassembly, per-channel flow control, and error control.

The SDP 433 refers to a protocol for discovering a service (or profile and protocol) supported by a Bluetooth device.

The BR/EDR protocols and profiles 432 and 431 define services (or profiles) using the Bluetooth BR/EDR and application protocols for exchanging such data.

The attribute protocol 436 is a server-client architecture, and defines a rule for accessing the data of a counterpart device. There are 6 message (i.e., a request message, a response message, a command message, a notification message, and an indication message) types as follows.
A request message from a client to a server with a response message from the server to the client.
A command message from a client to a server without a response message.
A notification message from a server to a client without a confirm message
An indication message from a server to a client with a confirm message from the client to the server.

The generic attribute profile (GATT) 435 defines the type of attribute.

The generic access profile (GAP) 434 defines device discovery, connection, and a scheme for providing a user with information and provides privacy.

As shown in FIG. 5, the BLE architecture includes a controller stack which may operate so that it processes a wireless device interface whose timing is important and a host stack which may operate so that it processes high-level data.

The controller stack may be called a controller, but is hereinafter called the controller stack in order to avoid confusion with the processor, that is, an internal element of the device described with reference to FIG. 2.

First, the controller stack may be implemented using a communication module which may include a Bluetooth wireless device and a processor module which may include a processing device, such as a microprocessor.

The host stack is part of an OS operating on the processor module and may be implemented as an instantiation of a package (pACKage) on the OS.

In some examples, the controller stack and the host stack may operate or may be executed on the same processing device within the processor module.

The host stack includes a generic access profile (GAP) 510, GATT based profiles 520, a generic attribute profile (GATT) 530, an attribute protocol (ATT) 540, a security manage (SM) 550, and a logical link control and adaptation protocol (L2CAP) 560. The host stack may include various protocols and profiles in addition to the elements.

The host stack multiplexes various protocols and profiles provided by the upper layer of Bluetooth using the L2CAP.

First, the logical link control and adaptation protocol (L2CAP) 560 provides a specific protocol or profile with one bidirectional channel for sending data.

The L2CAP may operate so that it multiplexes data between higher layer protocols, segments and reassembles packages, and manages the transmission of multicast data.

In the BLE technology, 3 fixed channels (e.g., one channel for a signaling channel, one channel for the security manager, and one channel for an attribute protocol) are used.

In contrast, in the basic rate/enhanced data rate (BR/EDR), dynamic channels are used, and a protocol service multiplexer, retransmission, and streaming mode are supported.

The SM 550 is a protocol for authenticating a device and providing a key distribution.

The ATT 540 is a server-client architecture, and defines a rule for accessing the data of a counterpart device. The ATT includes 6 message types (i.e., a request, a response, a command, notification, indication, and confirmation).

That is, \textcircled{1} the request message and \textcircled{2} the response message: the request message is a message for requesting specific information from a client device to a server device. The response message is a response message for a request message and refers to a message transmitted from a server device to a client device.

\textcircled{3} The command message is a message transmitted from a client device to a server device in order to indicate the command of a specific operation. A server device does not send a response to a command message to a client device.

\textcircled{4} The notification message is a message transmitted from a server device to a client device in order to provide notification of an event. A client device does not send a confirmation message for a notification message to a server device.

\textcircled{5} The indication message and the confirm message are messages transmitted from a server device to a client device in order to provide notification of an event. Unlike in the notification message, a client device sends a confirmation message for an indication message to a server device.

The GAP is a layer newly implemented for the BLE technology and is used to select a role for communication between BLE devices and control how a multi-profile operation is performed.

Furthermore, the GAP is chiefly used for device discovery, the formation of connection, and a security procedure part. The GAP defines a scheme for providing information to a user and defines the type of following attributes.

\textcircled{1} Service: Define the basic operation of a device through a combination of behaviors related to data

\textcircled{2} Include: Define the relationship between services

\textcircled{3} Characteristics: A data value used in a service

\textcircled{4} Behavior: A computer-readable format defined in a universal unique identifier (UUID) value type

The GATT-based profiles have dependency on the GATT and are chiefly applied to a BLE device. The GATT-based profiles may include a battery, time, FindMe, proximity, time, and an object delivery service. Detailed contents of the GATT-based profiles are as follows.

Battery: A battery information exchange method

Time: A time information exchange method

FindMe: Provide an alarm service according to the distance

Proximity: A battery information exchange method

Time: A time information exchange method

Call Control Service: A supportable codec information exchange method

The GATT may operate as a protocol that describes how the ATT is used when services are configured. For example, the GATT may operate so that it defines how ATT attributes are grouped with services and may operate so that it describes characteristics associated with services.

Accordingly, the GATT and the ATT may use characteristics in order to describe the state and services of a device and to describe how the characteristics are related and how the characteristics are used.

The controller stack includes a physical layer 590, a link layer 580, and a host controller interface (HCI) 570.

The physical layer (or wireless transmission/reception module) 590 is a layer for sending and receiving a radio signal of 2.4 GHz and uses Gaussian frequency shift keying (GFSK) modulation and a frequency hopping scheme including 40 RF channels.

The link layer 580 sends or receives a Bluetooth packet.

Furthermore, the link layer performs an advertising and scanning function using 3 advertising channels and provides a function for generating connection between devices and exchanging data packets of a maximum of 42 bytes through 37 data channels.

The host controller interface (HCI) provides an interface between the host stack and the controller stack, enables commands and data to be provided from the host stack to the controller stack, and enables events and data to be provided from the controller stack to the host stack.

Procedures of the Bluetooth low energy (BLE) technology are described in brief below.

The BLE procedures may be divided into a device filtering procedure, an advertising procedure, a scanning procedure, a discovering procedure, and a connection procedure.

Device Filtering Procedure

The device filtering procedure is a method of reducing the number of devices which perform responses to a request, indication, and notification in the controller stack.

When receiving a request, all devices do not need to make responses to the request. Accordingly, the controller stack may perform control so that power consumption is reduced in the BLE controller stack by reducing the number of transmitted requests.

An advertising device or a scanning device may perform the device filtering procedure in order to limit the number of devices which receive an advertising packet, a scan request, or a connection request.

In this case, the advertising device refers to a device that sends an advertising event, that is, performs advertising, and is also called an advertiser.

The scanning device refers to a device that performs scanning and a device that sends a scan request.

In the BLE technology, if a scanning device receives some advertising packets from an advertising device, the scanning device needs to send a scan request to the advertising device.

However, if the device filtering procedure is used and thus the transmission of a scan request is unnecessary, the scanning device may neglect the advertising packets transmitted by the advertising device.

The device filtering procedure may also be used in a connection request process. If device filtering is used in a connection request process, a response to a connection request does not need to be transmitted by neglecting the connection request.

Advertising Procedure

An advertising device performs the advertising procedure in order to perform non-directional broadcast to devices within an area.

In this case, the non-directional broadcast refers to broadcast in all directions not broadcast in a specific direction.

In contrast, directional broadcast refers to broadcast in a specific direction. The non-directional broadcast is generated without a connection procedure between an advertising device and a device in a listening state (hereinafter referred to as a “listening device”).

The advertising procedure is used to establish Bluetooth connection with a nearby initiator device.

Alternatively, the advertising procedure may be used to provide the periodic broadcast of user data to scanning devices which perform listening in an advertising channel.

In the advertising procedure, all the advertising (or advertising events) are broadcast through an advertising physical channel.

An advertising device may receive a scan request from a listening device which performs listening in order to obtain additional user data from the advertising device. An advertising device sends a response to a scan request to a device that has sent the scan request through the same advertising physical channel as an advertising physical channel through which the scan request has been received.

Broadcast user data transmitted as part of advertising packets is dynamic data. In contrast, scan response data is commonly static data.

An advertising device may receive a connection request from an initiator device on an advertising (broadcast) physical channel. If an advertising device has used an advertising event capable of being connected and an initiator device has not been filtered by the device filtering procedure, the advertising device stops advertising and enters connected mode. The advertising device may start the advertising again after connected mode.

Scanning Procedure

A device which performs scanning, that is, a scanning device, performs the scanning procedure in order to listen to the non-directional broadcast of user data from advertising devices which use an advertising physical channel.

A scanning device sends a scan request to an advertising device through an advertising physical channel in order to request additional user data from the advertising device. The advertising device sends a scan response, that is, a response to the scan request, including the additional user data requested by the scanning device, through the advertising physical channel.

The scanning procedure may be used for connection with another BLE device in a BLE piconet.

If a scanning device receives a broadcast advertising event and is in initiator mode in which a connection request may be initiated, the scanning device may start Bluetooth connection with an advertising device by sending a connection request to the advertising device through an advertising physical channel.

If a scanning device sends a connection request to an advertising device, the scanning device stops initiator mode scanning for additional broadcast and enters connected mode.

Discovering Procedure

Devices capable of Bluetooth communication (hereinafter referred to as a “Bluetooth device”) perform the advertising procedure and the scanning procedure in order to discover devices present nearby or to be discovered by other devices in a given area.

The discovering procedure is asymmetrically performed. A Bluetooth device trying to discover other surrounding devices is called a discovering device, and performs listening in order to discover devices which advertise advertising events which may be scanned. A Bluetooth device which is discovered by another device and may be used is called a discoverable device, and broadcasts an advertising event so that another device may actively scan the advertising event through an advertising (broadcast) physical channel.

Both a discovering device and a discoverable device may have already been connected to other Bluetooth devices in a piconet.

Connection Procedure

The connection procedure is asymmetrical. The connection procedure requests another Bluetooth device to perform a scanning procedure while a specific Bluetooth device performs an advertising procedure.

That is, the advertising procedure may become an object. As a result, only one device may respond to advertising. Connection may be initiated by receiving an advertising event which may be accessed from an advertising device and sending a connection request to the advertising device through an advertising (broadcast) physical channel.

An operation state in the BLE technology, that is, an advertising state, a scanning state, an initiating state, and a connection state, are described in brief below.

Advertising State

A link layer LL enters the advertising state in response to the indication of a host (stack). If the link layer is in the advertising state, the link layer sends advertising packet data units (PDU) in advertising events.

Each of the advertising events includes at least one advertising PDU. The advertising PDUs are transmitted through advertising channel indices which are used. An advertising event may be terminated if it has been transmitted through an advertising channel index in which an advertising PDU is used or may be terminated a little earlier if an advertising device needs to secure the space for performing other functions.

Scanning State

The link layer enters the scanning state in response to the indication of a host (stack). In the scanning state, the link layer listens to advertising channel indices.

The scanning state includes two types: passive scanning and active scanning. Each scanning type is determined by a host.

A separate time or advertising channel index for performing scanning is not defined.

In the scanning state, the link layer listens to an advertising channel index for scan window (scanWindow) duration. A scan interval (scanInterval) is defined as the interval between the start points of two consecutive scan windows.

If a collision is not present in scheduling, the link layer needs to perform listening in order to complete all the scan intervals of a scan window as indicated by a host. In each scan window, the link layer needs to scan another advertising channel index. The link layer uses all available advertising channel indices.

In the case of passive scanning, the link layer receives only packets, but does not send any packet.

In the case of active scanning, the link layer perform listening in order to request advertising PDUs and an advertising PDU type capable of requesting additional information related to an advertising device from the advertising device.

Initiating State

The link layer enters the initiating state in response to the indication of a host (stack).

When the link layer is in the initiating state, the link layer listens to advertising channel indices.

In the initiating state, the link layer listens to an advertising channel index for scan window duration.

Connection State

The link layer enters the connection state when a device performing a connection request, that is, an initiator device, sends a CONNECT_REQ PDU to an advertising device or when an advertising device receives a CONNECT_REQ PDU from an initiator device.

After the link layer enters the connection state, the formation of connection is taken into consideration. Such connection does not need to be taken into consideration at a point of time at which the link layer enters the connection state. A sole difference between newly formed connection and existing connection is a link layer connection supervision timeout value.

If two devices are connected, the two devices perform different roles.

A link layer functioning as a master is called a master, and a link layer functioning as a slave is called a slave. The master controls timing of a connection event, and the connection event refers to a point of time at which the master and the slave are synchronized.

Packets defined in the Bluetooth interface are described in brief below. BLE devices use packets defined below.

Packet Format

A link layer has only one packet format used for both an advertising channel packet and a data channel packet.

Each of the packets includes four fields: a preamble, an access address, a PDU, and CRC.

When one packet is transmitted in an advertising physical channel, the PDU may become an advertising channel PDU. When one packet is transmitted in a data physical channel, the PDU may become a data channel PDU.

Advertising Channel PDU

The advertising channel PDU has a header of 16 bits and a payload of various sizes.

The PDU type fields of the advertising channel PDU included in the header have PDU types defined in Table 1.

TABLE 1

| PDU Type | PACKet Name |
|---|---|
| 0000 | ADV-IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

Advertising PDU

The following advertising channel PDU types are called advertising PDUs and are used in detailed events.

ADV_IND: A non-directional advertising event capable of connection

ADV_DIRECT_IND: A directional advertising event capable of connection

ADV_NONCONN_IND: A non-directional advertising event incapable of connection

ADV_SCAN_IND: A non-directional advertising event capable of scanning

The PDUs are transmitted in the link layer in the advertising state and are received by the link layer in the scanning state or the initiating state.

Scanning PDUs

The following advertising channel PDU types are called scanning PDUs and are used in the state described below.

SCAN_REQ: It is transmitted by the link layer in the scanning state and is received by the link layer in the advertising state.

SCAN_RSP: It is transmitted by the link layer in the advertising state and is received by the link layer in the scanning state.

Initiating PDU

The following advertising channel PDU type is called an initiating PDU.

CONNECT_REQ: It is transmitted by the link layer in the initiating state and is received by the link layer in the advertising state.

Data Channel PDU

The data channel PDU has a header of 16 bits and a payload of various sizes and may include a message integrity check (MIC) field.

The procedures, state, and packet format in the BLE technology described above may be used to perform methods proposed in this specification.

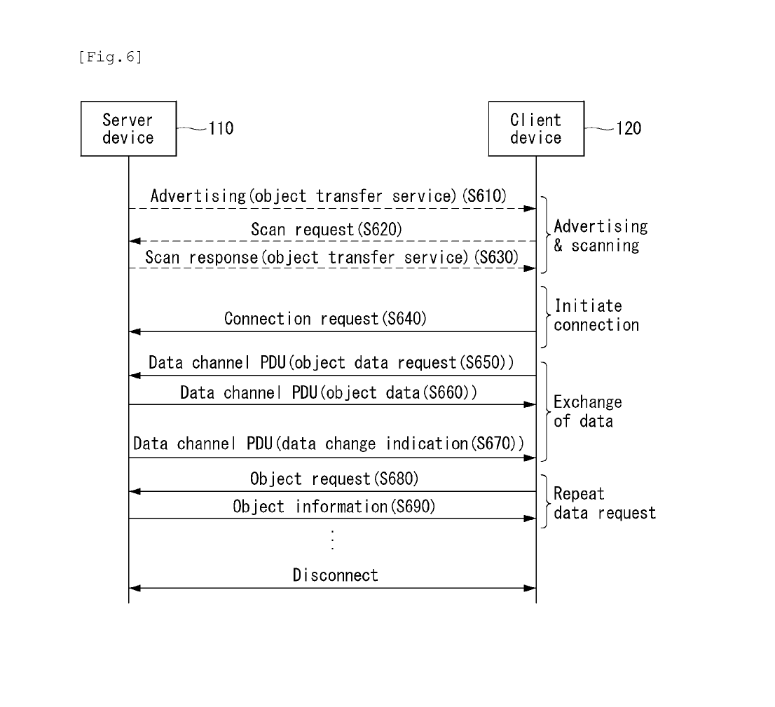

FIG. 6 is a flowchart illustrating an example of a method for providing an object transfer service in a BLE technology.

An object delivery service (or an object transfer service) refers to a service supported in BLE in order to transmit or receive an object, such as bulk data, or data in Bluetooth communication.

For a Bluetooth connection configuration between a server device and a client device, an advertising process and a scanning process corresponding to S610˜S630 are performed.

First, the server device transmits an advertising message to the client device in order to notify the client device of server device-related information including an object delivery service (S610).

The advertising message may be represented as an advertising PACKet Data Unit (PDU), an advertising packet, advertising, an advertising frame, or an advertising physical channel PDU.

The advertising message may include service information (including a service name) provided by the server device, the name of the server device, and manufacturer data.

Furthermore, the advertising message may be transmitted to the client device in a broadcast manner or a unicast manner.

Thereafter, the client device transmits a scan request message to the server device in order to be aware of more detailed information about the server device-related information (S620).

The scan request message may be represented as a scanning PDU, a scan request PDU, a scan request, a scan request frame, or a scan request packet.

Thereafter, the server device transmits a scan response message to the client device as a response to the scan request message received from the client device (S630).

The scan response message includes the server device-related information requested by the client device. In this case, the server device-related information may include an object or data which may be transmitted by the server device in relation to the provision of an object delivery service.

When the advertising process and the scanning process are terminated, the server device and the client device perform an initiating connection process and a data exchange process corresponding to S640˜S670.

More specifically, the client device transmits a connect request message to the server device for a Bluetooth communication with the server device (S640).

The connect request message may be represented as a connect request PDU, an initiation PDU, a connect request frame, or a connect request.

When the Bluetooth connection is set up between the server device and the client device through step S640, the server device and the client device exchange data. In the data exchange process, data may be transmitted and received through a data channel PDU.

The client device transmits an object data request to the server device through a data channel PDU (S650). The data channel PDU may be represented as a data request message or a data request frame.

Thereafter, the server device transmits the object data, requested by the client device, to the client device through a data channel PDU (S660).

In this case, the data channel PDU is used to provide data to a counterpart device or to request data from a counterpart device according to a method defined by the Attribute protocol.

Thereafter, when a change of data is generated in the server device, the server device transmits data change indication information to the client device through a data channel PDU in order to notify the client device of a change of the data or object (S670).

Thereafter, the client device requests changed object information from the server device in order to discover changed data or a changed object (S680).

Thereafter, the server device transmits object information, changed in the server device, to the client device as a response to the changed object information request (S690).

Thereafter, the client device discovers the changed data or object by comparing the received changed object information with the current object information of the client device.

The client device repeatedly performs step S680 to step S690 until it discovers the changed object or data.

Thereafter, if the connection state does not need to be maintained between the server device and the client device, the server device or the client device may disconnect the connection state.

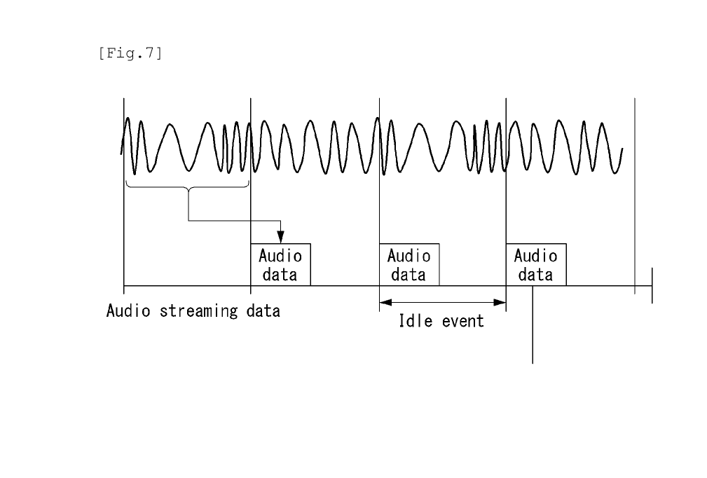

FIG. 7 is a diagram showing the characteristics of an audio signal.

From FIG. 7, it may be seen that in the case of an audio signal, audio streaming data or audio data is periodically generated at an idle event interval.

Audio data is generated periodically (or at a specific time interval) depending on its characteristic.

In this case, a specific time interval in which audio data is periodically generated may be represented as an idle event interval.

Each audio data is transmitted in each idle event interval.

Furthermore, each audio data may be transmitted through the entire idle event interval or some of the idle event interval.

If audio streaming data generated periodically or regularly as shown in FIG. 7 is transmitted using the BLE mechanism of FIG. 6, the procedures (i.e., the advertising and scanning procedures, the communication procedure, and the disconnection procedure) of FIG. 6 need to be performed whenever the generated audio data is transmitted and received.

As described above with reference to FIG. 7, however, in general, audio data is periodically generated, and a latency guarantee for the transmission of audio data is essential regardless of the amount of data.

However, if the procedures of FIG. 6 are performed whenever newly generated audio data is transmitted, there is a problem in that a latency is generated in transmitting the audio data.

The transmission of audio data through Hearing Aids (HA) or a headset may have high energy efficiency if the BLE technology is used rather than the Bluetooth BR/EDR technology because the amount of data generated is small. As described above, however, the data channel process of the BLE technology has large overhead in the transmission of data because advertising and a connection need to be performed whenever data is transmitted. In particular, a latency guarantee absolutely required for the transmission of audio data cannot be ensured.

Furthermore, in the data channel process of the BLE technology, intermittently generated data is transmitted when it is necessary, and the deep sleep of a BLE device is induced in other time domain in order to improve energy efficiency. Accordingly, it may be difficult to apply the data channel process of the BLE technology, such as that of FIG. 6, to the transmission of periodically generated audio data.

For such reasons, it is necessary to define a new mechanism for transmitting and receiving periodically generated data, such as audio streaming, using the BLE technology.

Hereinafter, methods for transmitting and receiving periodically generated data (e.g., audio data) using the BLE technology, which are proposed in this specification, are described in detail.

That is, in the BLE technology, a channel for transmitting and receiving periodically generated data is newly defined, and a related mechanism is additionally defined. Accordingly, a method for transmitting periodically generated data within a range that does not deteriorate energy performance of BLE is provided.

Terms, such as audio streaming data, audio data, audio streaming, and an audio stream used in this specification, may be construed as having the same meaning.

Hereinafter, audio data is representatively used, for convenience of understanding.

Definition of Isochronous Channel and Related Mechanism

In order to transmit periodically generated data using the BLE technology, a new channel, that is, an isochronous channel, is defined.

The isochronous channel is used to transmit isochronous data between devices (e.g., conductors-members) using an isochronous stream.

The isochronous data refers to data transmitted at a specific time interval, that is, periodically or regularly.

That is, the isochronous channel may mean a channel through which periodically generated data, such as audio data, is transmitted and received in the BLE technology.

The isochronous channel may be used to transmit and receive audio data to and from a single member, a set of one or more coordinated members, or a plurality of members.

Furthermore, the isochronous channel corresponds to a flushing channel which may be used to transmit and receive an isochronous stream, such as audio streaming, or important data in different time domains.

Methods using an isochronous channel to be described hereunder operate independently of an advertising channel and a data channel used in the existing (v4.2 or lower) BLE technology.

Furthermore, in the methods proposed in this specification, a new frequency channel and a new frequency hopping interval for an isochronous channel may be additionally defined.

The isochronous channel enables an isochronous stream, such as flushable data (e.g. time-bound audio data), to be transmitted from a conductor to one or one or more members using BLE.

In this case, a conductor may also be represented as a master, and a member may also be represented as a slave.

Furthermore, security may be set in or may not be set in the isochronous channel.

Furthermore, the isochronous channel may be set up in various topologies in order to permit the transmission of an isochronous stream between a single conductor and a single member, between a single conductor and hearing aids or a pair of coordinated members that produce stereo audio, such as stereo headsets, or a single conductor and a plurality of members synchronized with the same isochronous stream(s).

In this case, the member may transmit data to a conductor through the same isochronous channel.

Furthermore, the isochronous channel can support personal audio and can also support the transmission and reception of shared audio, public audio, and broadcast audio.

The setup procedure of the isochronous channel requires the hierarchy of profile level security and reliability requirements to satisfy different use cases.

Furthermore, the isochronous channel may be used for various applications, and thus may include a plurality of audio sources and sinks. Furthermore, the isochronous channel may include complicated topologies for allowing users to regularly change or share different audio streams.

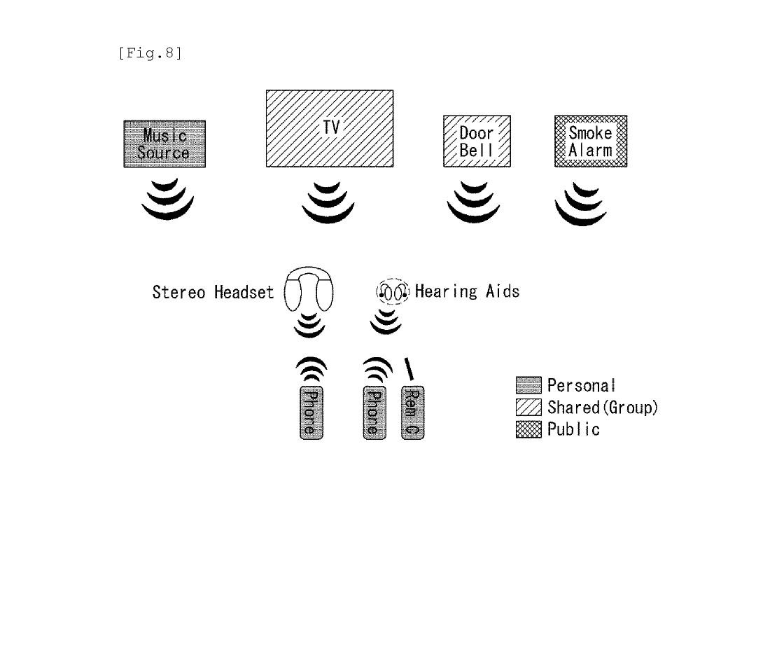

FIG. 8 is a diagram showing an example of a home ecosystem for applications in which an isochronous channel proposed in this specification may be used.

That is, FIG. 8 shows an example of the space in which a plurality of audio conductors and members to which the methods proposed in this specification may be applied can move inside/outside their areas.

As shown in FIG. 8, the presence of various conductors and members may mean that an isochronous channel is required in order for a member to obtain information necessary to set up the isochronous channel as a method for providing notification of the presence of the member.

Furthermore, the isochronous channel may be used to transmit and receive non-audio data.

A member may use isochronous channels in order to determine whether notification messages which may include information obtained from conductors within a BLE communication range are present.

Furthermore, a member may use isochronous channels in order to receive a request for control information or service data from one or one or more devices that behave like a remote controller.

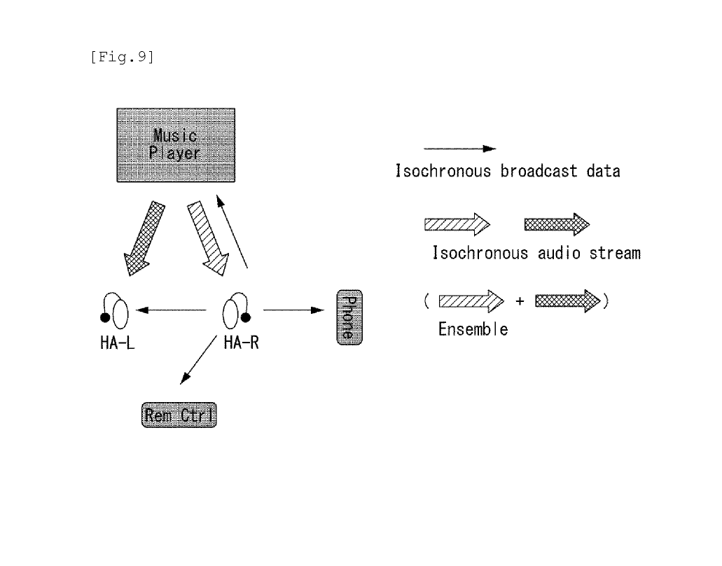

FIG. 9 is a diagram showing an example in which an isochronous channel proposed in this specification may be used.

That is, FIG. 9 shows an example which a pair of Hearing Aids (HA) is connected to a plurality of conductors and remote control devices through an isochronous channel.

As shown in FIG. 9, a right hearing aid (HA-R) behaves as a conductor for broadcasting data through an isochronous channel.

Furthermore, the right HA may transmit a control request to all of devices that had been connected to the right HA before, such as the remote controller of the right HA, a phone, a music player, and a coordinated left hearing aid (HA-L).

The left HA and/or the right HA may behave as conductors in a scenario, such as that of FIG. 9.

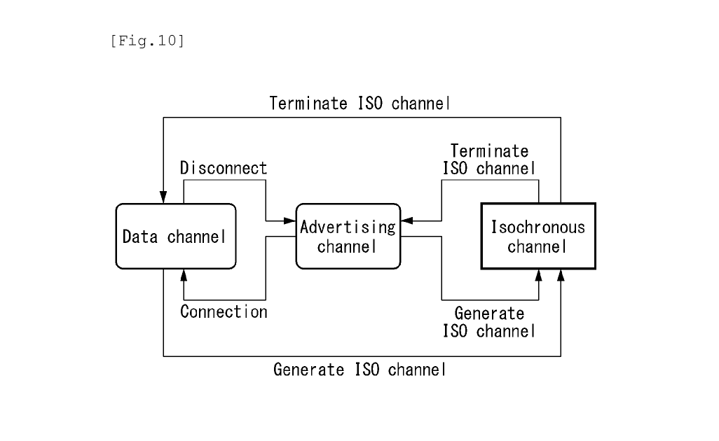

FIG. 10 is a diagram showing an example of an operating state transition procedure in the BLE technology which is proposed in this specification.

As described above, an isochronous (ISO) channel may operate along with an Adv channel and a data channel in the BLE technology.

Referring to FIG. 10, a BLE device may switch from an Adv state to (1) a first connection state or (2) a second connection state for the transmission and reception of data.

In this case, the first connection state refers to an operating state in which the BLE device transmits and receives data through a data channel. The second connection state refers to an operating state in which the BLE device transmits and receives data through an isochronous channel.

The BLE device changes its operating state to the first connection state or the second connection state depending on the type of data transmitted and received between devices and a data transfer form.

More specifically, the BLE device generates the data channel through the Adv channel in order to operate in the first connection state and generates the isochronous channel through the Adv channel in order to operate in the second connection state.

The isochronous channel is established by the aforementioned conductor. Members may receive information related to the isochronous channel transmitted by the conductor and use the isochronous channel in synchronism with the conductor.

In this case, the member may receive the information related to the isochronous channel using one of the following two methods.
Transmission through a link layer control PDU
Transmission through an advertising PDU

In order to receive the information related to the isochronous channel through the link layer control PDU, the member needs to be connected to the conductor through Bluetooth LE and may receive detailed information related to the isochronous channel from the conductor through a link layer control procedure.

If the member is not connected to the conductor or does not have information about the hop sequence of the conductor, the member may receive the information related to the isochronous channel through the advertising PDU.

Furthermore, when the BLE device switches from the first connection state to the Adv state, it releases a generated data channel. When the BLE device switches from the second connection state to the Adv state, it releases a generated isochronous channel.

By way of example, in order to transmit and receive audio data, the BLE device switches from the Adv state to the second connection state. That is, the BLE device may transmit and receive audio data through an isochronous channel in the second connection state.

Furthermore, in order to transmit and receive data that is irregularly generated or intermittently generated, the BLE device switches from the Adv state to the first connection state.

That is, the BLE device may transmit and receive the corresponding data through a data channel in the first connection state.

As shown in FIG. 10, the BLE device generates a data channel in the Adv state, switches to the first connection state, and transmits and receives data through the generated data channel.

When the transmission and reception of the data through the data channel are completed, the BLE device terminates the generated data channel and returns to the Adv state, that is, an Adv channel.

Likewise, the BLE device generates an isochronous channel in the Adv state, switches to the second connection state, and transmits and receives data through the generated isochronous channel.

When the transmission and reception of data through the isochronous channel are completed, the BLE device terminates the generated isochronous channel and returns to the Adv state, that is, an Adv channel.

As described above, an isochronous channel may be generated in order to transmit and receive periodically generated data, such as audio data. A data channel may be generated in order to transmit and receive irregular or intermittent data.

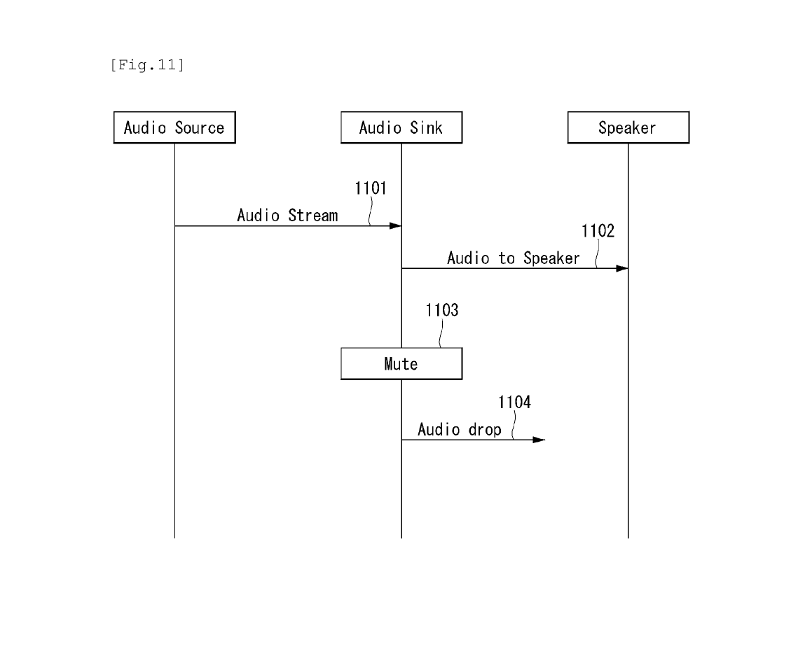

FIG. 11 is a diagram illustrating problems of a mute function used in an existing Bluetooth system.

An existing mute function is described with reference to FIG. 11. First, an audio source device transmits audio streaming data to an audio sink device at step S1101. The audio sink device that has received the audio streaming data outputs the audio streaming data through a speaker included in the audio sink device at step S1102.

While the audio sink device outputs the audio streaming data through the speaker, a mute function is executed in response to input from a user at step S1103. When the mute function is executed, the audio sink device drops the received audio streaming data without outputting it through the speaker at step S1104.

That is, the existing mute function is used to simply turn on and off only a portion output from a local system to a speaker. Even after the mute function is executed, the transmission and reception of the audio streaming data between the audio source device and the audio sink device are not stopped.

Accordingly, the existing mute function is problematic in that unnecessary power is consumed due to the continuous transmission of audio data by the audio source device and the continuous reception of audio data by the audio sink device.

In order to solve such a problem, an embodiment of the present invention proposes a method for controlling audio streaming using a remote mute and remote un-mute function.

Hereinafter, the term “set up” an isochronous channel may mean the state in which the audio source device described with reference to FIG. 10 may configure an isochronous channel or the audio sink device may receive information related to a configured isochronous channel and transmit and receive streaming data in synchronism.

Furthermore, the term “remove” an isochronous channel may mean that audio streaming data is not transmitted and received through an isochronous channel.

A detailed description is given with reference to related drawings.

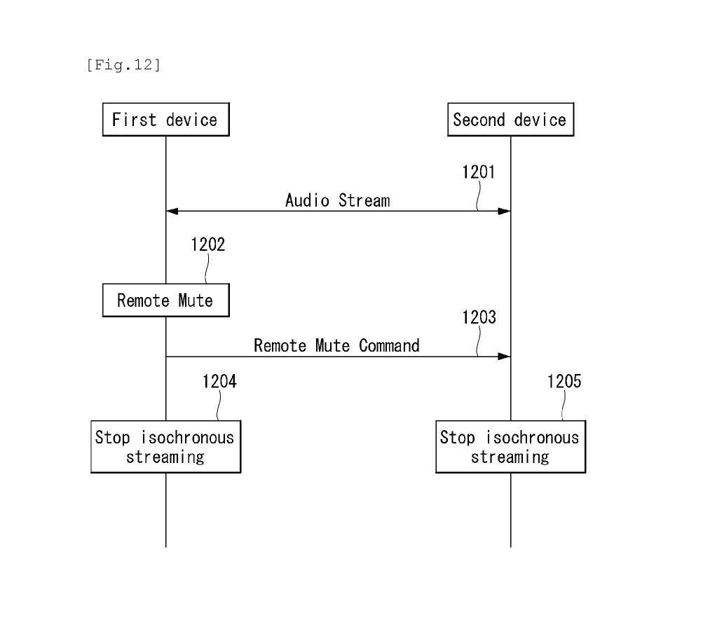

FIG. 12 is a diagram showing an example of a remote mute method of audio streaming in accordance with an embodiment to which the present invention may be applied.

A first device may be an audio source device for transmitting audio streaming data to a second device or may be an audio sink device for receiving audio streaming data from a second device.

In FIG. 12, audio streaming is illustrated as being transmitted bidirectionally, for convenience of description, but if the first device is an audio source device, the first device transmits audio streaming. In this case, the second device is an audio sink device and receives the audio streaming. In contrast, if the first device is an audio sink device, the first device receives audio streaming. In this case, the second device is an audio source device and transmits the audio streaming.

Referring to FIG. 12, the first device transmits audio streaming data to the second device or receives audio streaming data from the second device at step S1201.

While the audio streaming data is transmitted and received between the first device and the second device, when the first device receives a remote mute command from a user or receives a remote mute command from an external device connected to the first device, the first device executes a remote mute at step S1202. When the remote mute is executed, the first device transmits a remote mute command to the second device at step S1203. The first device transmits the remote mute command to the second device and removes a channel used for the transmission and reception of the audio streaming at step S1204. Accordingly, the transmission or reception of audio data by the first device is stopped.

The second device that has received the remote mute command from the first device removes a channel used for the transmission and reception of the audio streaming at step S1205. Accordingly, the transmission or reception of the audio data by the second device is stopped.

The audio streaming may be transmitted through an isochronous channel for transmitting isochronous data. For example, if audio streaming is transmitted and received through an isochronous channel, when a remote mute is executed, the first device may transmit a remote mute command to the second device and remove the isochronous channel. The second device may receive the remote mute command and remove the isochronous channel.

Furthermore, the first device may transmit the remote mute command to the second device through the same channel as the channel used for the transmission and reception of the audio streaming or may transmit the remote mute command to the second device through a channel different from the channel used for the transmission and reception of the audio streaming. For example, the remote mute command may be transmitted through an Asynchronous Connection Logical transport (ACL) channel of separate channels.

For example, if a remote mute command is transmitted through a separate channel, a channel used for the transmission and reception of a control message, such as a remote mute command, may be maintained and only a channel used for the transmission and reception of audio streaming may be removed because a transmission and reception channel for audio data and a control message channel are separated and used.

Furthermore, an example including a step of transmitting, by the first device, information related to a “callsetup” to the second device is described below. The remote mute may be performed based on the information related to the callsetup.

For example, the information related to the callsetup may be used between the transmission and reception of audio streams between a Hands Free (HF) and an Audio Gateway (AG). If the HF does not want to use the AG's in-band ring tone, the HF may mute an audio connection by receiving information whose callsetup value is set to 1. Furthermore, the HF may un-mute an audio connection by receiving information whose callsetup value has been set to 0. A remote mute may be performed in the AG based on the setting of the callsetup value.

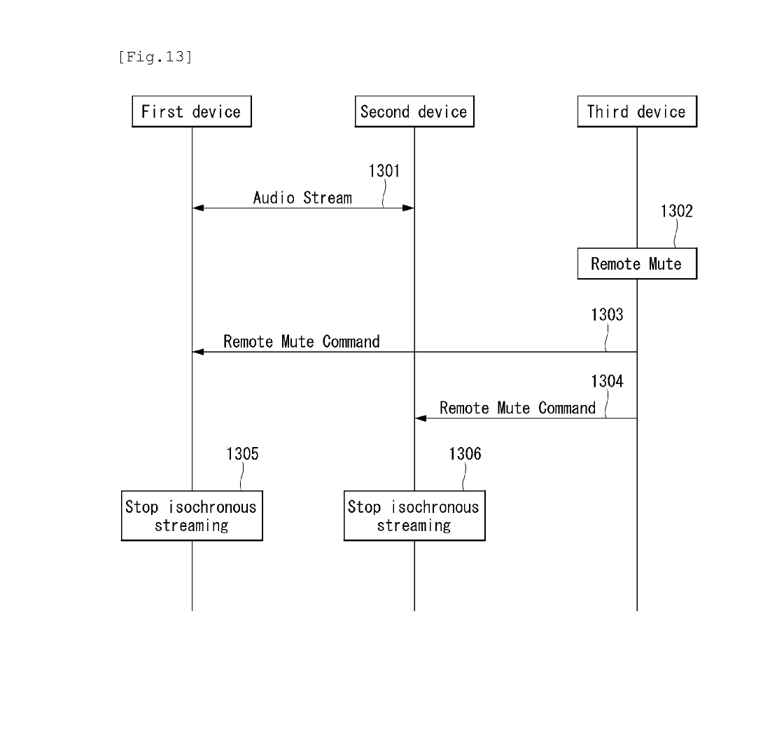

FIG. 12 has illustrated a method for executing, by an audio source device or an audio sink device, a remote mute function and removing a channel used for the transmission and reception of audio streaming. A remote mute may be executed by a remote controller other than an audio source device or an audio sink device. Such a remote mute is described with reference to FIG. 13.

FIG. 13 is a diagram showing another example of a remote mute method of audio streaming using a remote controller in accordance with an embodiment to which the present invention may be applied.

In FIG. 13, audio streaming is illustrated as being transmitted bidirectionally, for convenience of description, but if a first device is an audio source device, the first device transmits audio streaming. In this case, a second device is an audio sink device and receives audio streaming. In contrast, if the first device is an audio sink device, the first device receives audio streaming. In this case, the second device is an audio source device and transmits the audio streaming.

Referring to FIG. 13, the first device transmits audio streaming data to the second device or receives audio streaming data from the second device at step S1301.

While the audio streaming is transmitted and received between the first device and the second device, if a third device receives a remote mute command from a user or receives a remote mute command from an external device connected to the third device, the third device executes a remote mute at step S1302. When the remote mute is executed, the third device transmits a remote mute command to the first device at step S1303.

Thereafter, the third device transmits a remote mute command to the second device at step S1304. FIG. 13 is an expression of an example of the transmission of a remote mute command by the third device. The remote mute commands may be transmitted to the first device and the second device at the same time. After the remote mute command is transmitted to the second device, the remote mute command may be transmitted to the first device.

The first device that has received the remote mute command removes a channel used for the transmission and reception of the audio streaming at step S1305. Accordingly, the transmission or reception of the audio data by the first device is stopped.

The second device that has received the remote mute command from the third device removes a channel used for the transmission and reception of the audio streaming at step S1306. Accordingly, the transmission or reception of the audio data by the second device is stopped.

Furthermore, the third device may transmit the remote mute command through the same channel as a channel used for the transmission and reception of the audio streaming and may transmit the remote mute command through a channel different from a channel used for the transmission and reception of the audio streaming. For example, if the remote mute command is transmitted through a separate channel, it may be transmitted through an ACL channel of separate channels.

For example, if the remote mute command is transmitted through a separate channel, a channel used for the transmission and reception of a control message may be maintained and due to the execution of a remote mute only a channel used for the transmission and reception of audio streaming may be removed because an audio data transmission and reception channel and a control message transmission and reception channel are separated and used.

Furthermore, the audio streaming may be transmitted through an isochronous channel for transmitting isochronous data. For example, if audio streaming is transmitted and received through an isochronous channel, when a remote mute is executed, the first device may receive a remote mute command and remove the isochronous channel. The second device may receive the remote mute command and remove the isochronous channel.

The third device may be a remote controller fabricated to remotely control the audio source device and the audio sink device and may be included as part of the elements of a variety of types of portable devices, such as Hearing Aids (HA), a headset, an earphone, a PDA, and a smart phone.

A variety of types of portable devices, such as Hearing Aids (HA), a headset, an earphone, a notebook computer, and a smart phone, may also be an audio source device and at the same time may be an audio sink device.

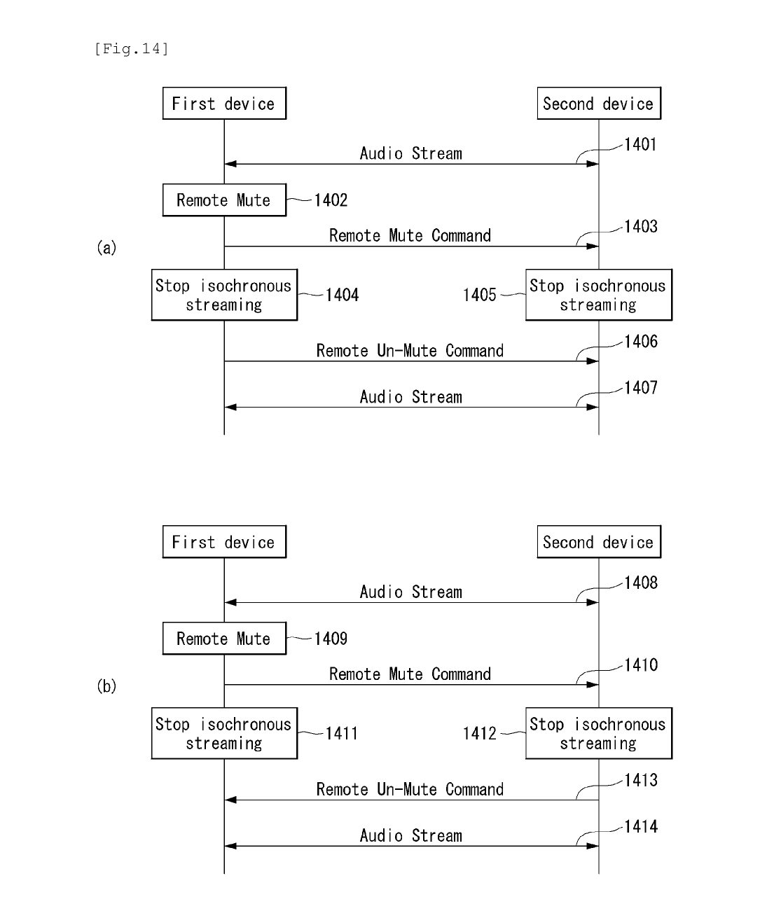

The remote mute method for controlling the transmission and reception of audio streaming has been described above. After a remote mute is executed, a remote un-mute for releasing the remote mute may be performed. A remote un-mute performed by an audio sink device or audio source device after a remote mute is executed is described below with reference to FIG. 14.

FIG. 14 is a diagram showing an example of a remote mute method and remote un-mute method of audio streaming according to an embodiment of the present invention.

In FIGS. 14(a) and 14(b), audio streaming is illustrated as being transmitted bidirectionally, for convenience of description, but if a first device is an audio source device, the first device transmits audio streaming. In this case, a second device is an audio sink device and receives the audio streaming. In contrast, if the first device is an audio sink device, the first device receives audio streaming. In this case, the second device may be an audio source device and may transmit the audio streaming.

Referring to FIG. 14(a), the first device transmits audio streaming data to the second device or receives audio streaming data from the second device at step S1401.

While the audio streaming is transmitted and received between the first device and the second device, when the first device receives a remote mute command from a user or receives a remote mute command from an external device connected to the first device, the first device executes a remote mute at step S1402. When the remote mute is executed, the first device transmits a remote mute command to the second device at step S1403. The first device transmits the remote mute command to the second device and removes a channel used for the transmission and reception of the audio streaming at step S1404. Accordingly, the transmission or reception of the audio data by the first device is stopped.

The second device that has received the remote mute command from the first device removes a channel used for the transmission and reception of the audio streaming at step S1405. Accordingly, the transmission or reception of the audio data by the second device is stopped.

While the remote mute is executed, the first device may transmit a remote un-mute command for releasing the remote mute to the second device at step S1406. When the second device receives the remote un-mute command, the first device and the second device may set up a channel used for the transmission and reception of audio streaming and resume the transmission and reception of the audio streaming using the channel at step S1407.

Referring to FIG. 14(b), the first device transmits audio streaming data to the second device or receives audio streaming data from the second device at step S1408.

While the audio streaming is transmitted and received between the first device and the second device, when the first device receives a remote mute command from a user or receives a remote mute command from an external device connected to the first device, the first device executes a remote mute at step S1409. When the remote mute is executed, the first device transmits a remote mute command to the second device at step S1410. The first device transmits the remote mute command to the second device and removes a channel used for the transmission and reception of the audio streaming at step S1411. Accordingly, the transmission or reception of the audio data by the first device is stopped.

The second device that has received the remote mute command from the first device removes a channel used for the transmission and reception of the audio streaming at step S1412. Accordingly, the transmission or reception of the audio data by the second device is stopped.

While the remote mute is executed, the second device may transmit a remote un-mute command for releasing the remote mute to the first device at step S1413. When the first device receives the remote un-mute command, the first device and the second device may set up a channel used for the transmission and reception of audio streaming and resume the transmission and reception of the audio streaming using the channel at step S1414.

Although a remote mute has been executed by the first device, not only the first device, but the second device may release the remote mute.

Furthermore, the audio streaming may be transmitted through an isochronous channel for transmitting isochronous data. For example, in this case, the first device may set up an isochronous channel with the second device through the transmission or reception of a remote audio un-mute command.

Furthermore, the remote mute command and the remote un-mute command may be transmitted through the same channel as a channel used for the transmission and reception of the audio streaming or may be transmitted through a separate channel other than a channel used for the transmission and reception of the audio streaming. For example, the remote mute command and the remote un-mute command may be transmitted through an ACL channel of separate channels.

For example, if the remote un-mute command is transmitted through a separate channel, a channel used for the transmission and reception of a control message may be maintained and due to the execution of a remote mute only a channel used for the transmission and reception of audio streaming may be removed because an audio data transmission and reception channel and a control message transmission and reception channel are separated and used.

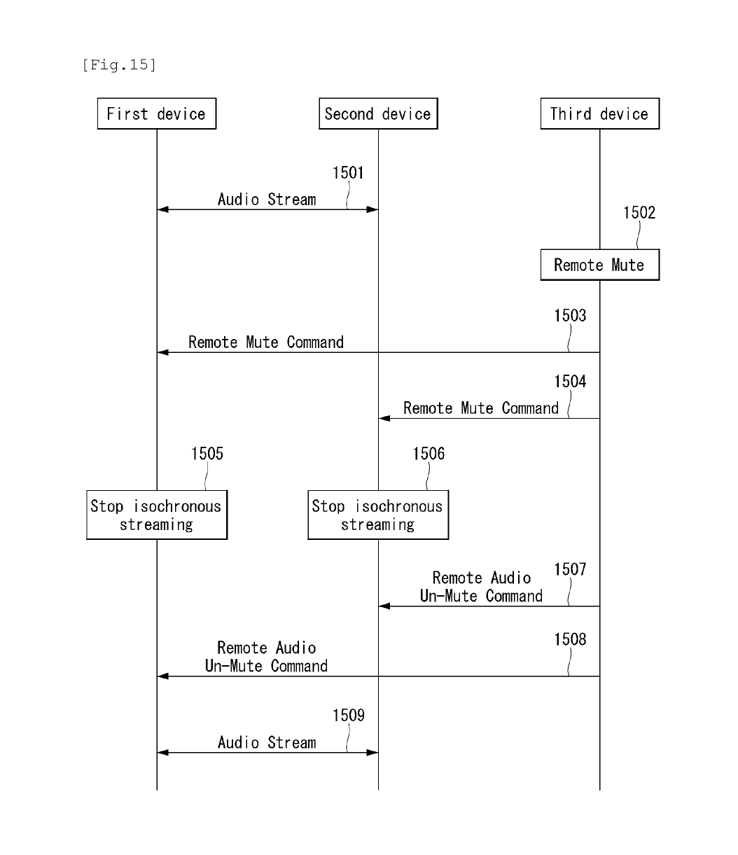

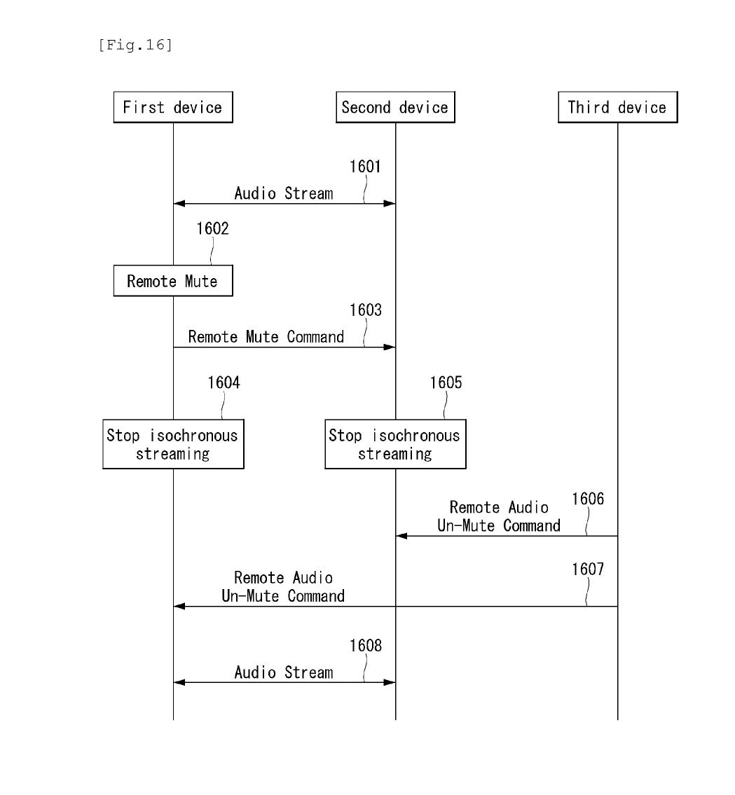

FIG. 14 has illustrated a method for releasing, by an audio source device or an audio sink device, a remote mute and resuming the transmission and reception of audio streaming. A remote mute may be released by a remote controller other than an audio source device or an audio sink device. This is described below with reference to FIGS. 15 and 16.

FIGS. 15 and 16 are diagrams showing various examples of a remote mute method and remote un-mute method of audio streaming using a remote controller according to embodiments of the present invention.

In FIGS. 15 and 16, audio streaming is illustrated as being transmitted bidirectionally, for convenience of description, but if a first device is an audio source device, the first device transmits audio streaming. In this case, a second device is an audio sink device and receives the audio streaming. In contrast, if the first device is an audio sink device, the first device receives audio streaming. In this case, the second device is an audio source device and transmits the audio streaming.

Referring to FIG. 15, the first device transmits audio streaming data to the second device or receives audio streaming data from the second device at step S1501.

While the audio streaming is transmitted and received between the first device and the second device, when a third device receives a remote mute command from a user or receives a remote mute command from an external device connected to the third device, the third device executes a remote mute at step S1502. When the remote mute is executed, the third device transmits a remote mute command to the first device at step S1503.

Furthermore, the third device transmits a remote mute command to the second device at step S1504. FIG. 15 is an expression of an example of the transmission of a remote mute command by the third device. The remote mute commands may be transmitted to the first device and the second device at the same time. After the remote mute command is transmitted to the second device, the remote mute command may be transmitted to the first device.

The first device that has received the remote mute command removes a channel used for the transmission and reception of the audio streaming at step S1505. Accordingly, the transmission or reception of the audio data by the first device is stopped.

The second device that has received the remote mute command from the third device removes a channel used for the transmission and reception of the audio streaming at step S1506. Accordingly, the transmission or reception of the audio data by the second device is stopped.

While the remote mute is executed, the third device may transmit a remote un-mute command for releasing the remote mute to the second device at step S1507. Furthermore, the third device transmits a remote un-mute command to the first device at step S1508. FIG. 15 is an expression of an example of the transmission of a remote un-mute command by the third device. The remote un-mute commands may be transmitted to the first device and the second device at the same time. After the remote un-mute command is transmitted to the first device, the remote un-mute command may be transmitted to the second device.

When the first device and the second device receive the remote un-mute commands, the first device sets up a channel to be used for the transmission and reception of audio streaming with the second device and resumes the transmission and reception of the audio streaming using the channel at step S1509.

Furthermore, the audio streaming may be transmitted through an isochronous channel for transmitting isochronous data. For example, in this case, the first device may set up an isochronous channel with the second device through the transmission or reception of a remote audio un-mute command.

The third device may be a remote controller fabricated to remotely control the audio source device and the audio sink device and may be included as part of the elements of a variety of types of portable devices, such as Hearing Aids (HA), a headset, an earphone, a PDA, and a smart phone.

A variety of types of portable devices, such as Hearing Aids (HA), a headset, an earphone, a PDA, a notebook computer, and a smart phone, may also be an audio source device and at the same time may be an audio sink device.

Furthermore, the third device may transmit the remote mute command and the remote un-mute command to the second device through the same channel as a channel used for the transmission and reception of the audio streaming or may transmit them to the second device through a channel different from a channel used for the transmission and reception of the audio streaming. For example, if the remote mute command and the remote un-mute command are transmitted through a separate channel, they may be transmitted through an ACL channel of separate channels.

For example, if the remote mute command and the remote un-mute command are transmitted through a separate channel, a channel used for the transmission and reception of a control message, such as the remote un-mute command, may be maintained and only a channel used for the transmission and reception of audio streaming may be removed because a data transmission and reception channel and a control message channel are separated and used.

Referring to FIG. 16, a first device transmits audio streaming data to a second device or receives audio streaming data from the second device at step S1601.

While the audio streaming is transmitted and received between the first device and the second device, when the first device receives a remote mute command from a user or receives a remote mute command from an external device connected to the first device, the first device executes a remote mute at step S1602. When the remote mute is executed, the first device transmits a remote mute command to the second device at step S1603. The first device transmits the remote mute command to the second device and removes a channel used for the transmission and reception of the audio streaming at step S1604. Accordingly, the transmission or reception of the audio data by the first device is stopped.

The second device that has received the remote mute command from the first device removes a channel used for the transmission and reception of the audio streaming at step S1605. Accordingly, the transmission or reception of the audio data by the second device is stopped.

While the remote mute is executed, a third device may transmit a remote un-mute command for releasing the remote mute to the second device at step S1606. Furthermore, the third device transmits a remote un-mute command to the first device at step S1607. FIG. 16 is an expression of an example of the transmission of a remote un-mute command by the third device. The remote un-mute commands may be transmitted to the first device and the second device at the same time. After the remote un-mute command is transmitted to the first device, the remote un-mute command may be transmitted to the second device.

When the first device and the second device receive the remote un-mute commands, the first device sets up a channel to be used for the transmission and reception of audio streaming with the second device and resumes the transmission and reception of the audio streaming using the channel at step S1608.

Furthermore, the audio streaming may be transmitted through an isochronous channel for transmitting isochronous data. For example, in this case, the first device may set up an isochronous channel with the second device through the transmission or reception of a remote audio un-mute command.

Although the remote mute has been executed by the first device, the remote mute may be released by the third device in addition to the first device.

The third device may be a remote controller fabricated to remotely control the audio source device and the audio sink device and may be included as part of the elements of a variety of types of portable devices, such as Hearing Aids (HA), a headset, an earphone, a PDA, and a smart phone.

A variety of types of portable devices, such as Hearing Aids (HA), a headset, an earphone, a PDA, a notebook computer, and a smart phone, may also be an audio source device and at the same time may be an audio sink device.

Furthermore, the remote mute command and the remote un-mute command may be transmitted through the same channel as a channel used for the transmission and reception of the audio streaming or may be transmitted through a channel different from a channel used for the transmission and reception of the audio streaming. For example, the remote mute command and the remote un-mute command may be transmitted through an ACL channel of separate channels.

For example, if the remote mute command and the remote un-mute command are transmitted through a separate channel, a channel used for the transmission and reception of a control message may be maintained and due to the execution of a remote mute only a channel used for the transmission and reception of audio streaming may be removed because an audio data transmission and reception channel and a control message transmission and reception channel are separated and used.

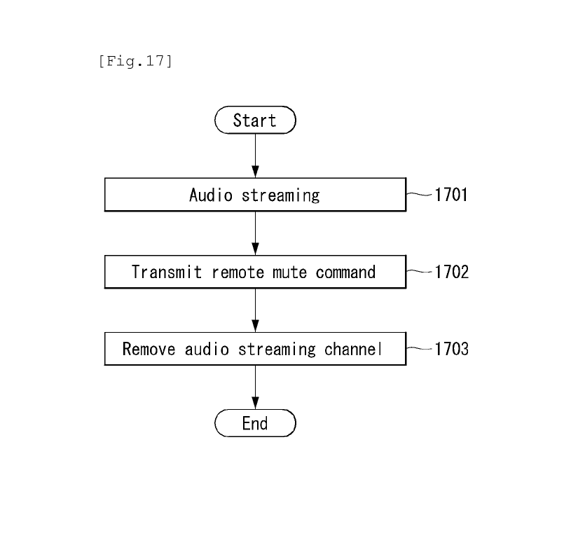

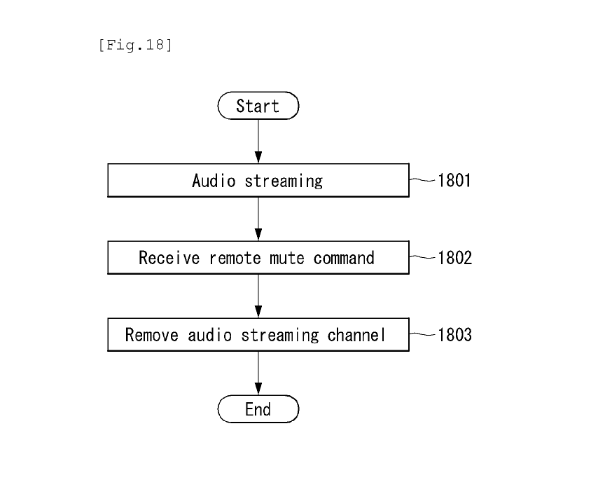

FIGS. 17 and 18 are flowcharts illustrating examples of a remote mute method of audio streaming according to embodiments of the present invention.

Referring to FIG. 17, first, a first device transmits audio streaming to a second device or receives audio streaming from the second device at step S1701. While the audio streaming is transmitted or received, the first device transmits a remote mute command for stopping the transmission or reception of the audio streaming to the second device at step S1702.

When the remote mute command is transmitted to the second device, the first device removes a channel used for the transmission or reception of the audio streaming at step S1703. Accordingly, the transmission and reception of the audio streaming between the first device and the second device are stopped.

Referring to FIG. 18, first, a first device transmits audio streaming to a second device or receives audio streaming from the second device at step S1801. While the first device transmits or receives the audio streaming, it receives a remote mute command for stopping the transmission or reception of the audio streaming from the second device or a third device at step S1802. When the first device receives the remote mute command, the first device removes a channel used for the transmission or reception of the audio streaming at step S1803. Accordingly, the transmission and reception of the audio streaming between the first device and the second device are stopped.

Embodiments including only one audio source device and only one audio sink device have been described. A remote mute function and a remote un-mute function may be used even if the number of audio sink devices is two. Such an example is described below. If the number of audio sink devices is two, for example, it may correspond to an example in which a headset is separated into the left side and the right side and used.

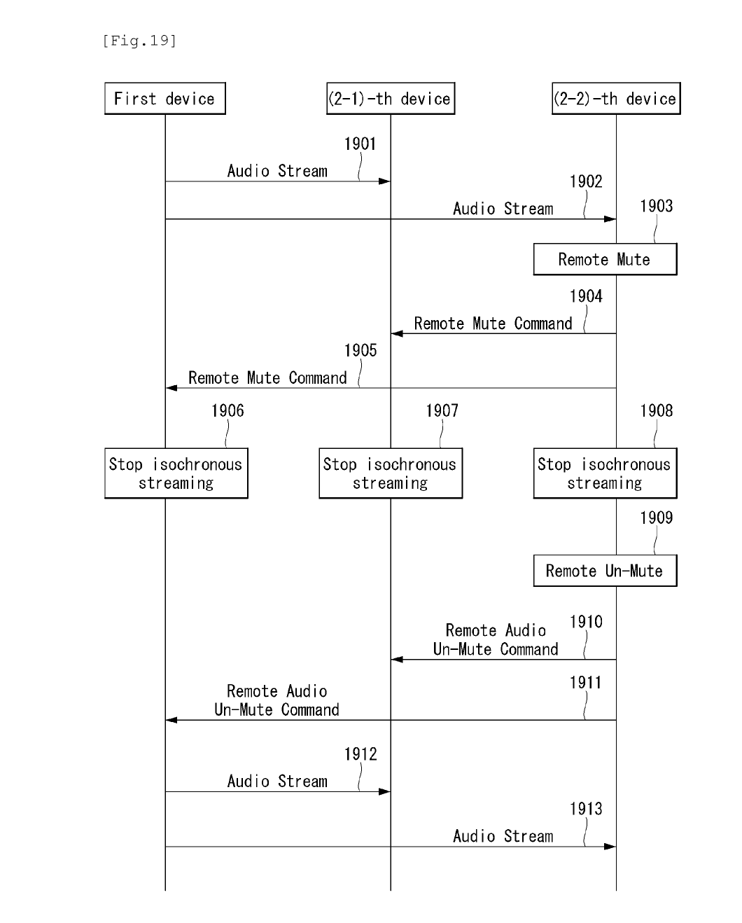

FIG. 19 is a diagram showing an example of a remote mute method and remote un-mute method of audio streaming according to an embodiment of the present invention.

In FIG. 19, a first device may be an audio source device, and a (2-1)-th device and a (2-2)-th device may be audio sink devices.

The first device transmits audio streaming to the (2-1)-th device at step S1901. The first device transmits audio streaming to the (2-2)-th device at step S1902.

While the audio streaming is transmitted and received, when the (2-2)-th device receives a remote mute command from a user or receives a remote mute command from an external device connected to the (2-2)-th device, it executes a remote mute at step S1903.

When the remote mute is executed, the (2-2)-th device transmits a remote mute command to the (2-1)-th device at step S1904. Furthermore, the (2-2)-th device transmits a remote mute command to the first device at step S1905. The remote mute command has been illustrated as being first transmitted to the (2-1)-th device, for convenience of description. In some embodiments, when the remote mute is executed, the (2-2)-th device may first transmit the remote mute command to the first device and then transmit the remote mute command to the (2-1)-th device or may transmit the remote mute commands to the first device and the (2-1)-th device at the same time.

The first device receives the remote mute command and removes a channel used for the transmission and reception of the audio streaming at step S1906. Accordingly, the transmission of the audio data by the first device is stopped.

The (2-1)-th device that has received the remote mute command from the (2-2)-th device removes a channel used for the reception of the audio streaming at step S1907. Accordingly, the reception of the audio data by the (2-1)-th device is stopped.

The (2-2)-th device transmits the remote mute commands to the first device and the (2-1)-th device, the (2-2)-th device and removes a channel used for the reception of the audio streaming at step S1908. Accordingly, the reception of the audio data by the (2-2)-th device is stopped.

While the transmission and reception of the audio streaming are stopped, when the (2-2)-th device receives a remote un-mute command from a user or receives a remote un-mute command from an external device connected to the (2-2)-th device, it releases the remote mute at step S1909.

When the remote mute is released, the (2-2)-th device transmits a remote un-mute command to the (2-1)-th device at step S1910. Furthermore, the (2-2)-th device transmits a remote un-mute command to the first device at step S1911. The remote un-mute command has been illustrated as being first transmitted to the (2-1)-th device, for convenience of description. For example, when the remote mute is released, the (2-2)-th device may first transmit the remote un-mute command to the first device and transmit the remote un-mute command to the (2-1)-th device or may transmit the remote un-mute commands to the first device and the (2-1)-th device at the same time.

When the first device and the (2-1)-th device receive the remote un-mute commands, the first device sets up a channel to be used for the transmission and reception of audio streaming with the (2-1)-th device and resumes the transmission and reception of the audio streaming using the channel at step S1912.

Furthermore, when the first device receives the remote un-mute command, the first device and the (2-2)-th device set up a channel used for the transmission and reception of audio streaming and resume the transmission and reception of the audio streaming using the channel at step S1913.

Furthermore, the audio streaming may be transmitted through an isochronous channel for transmitting isochronous data. For example, in this case, the first device may set up an isochronous channel with the (2-1)-th device and the first device may set up an isochronous channel with the (2-2)-th device through the transmission or reception of a remote audio un-mute command.

Furthermore, the (2-2)-th device may transmit the remote mute command and the remote un-mute command to the first device or the (2-1)-th device through the same channel as a channel used for the transmission and reception of the audio streaming or may transmit them to the first device or the (2-1)-th device through a channel different from a channel used for the transmission and reception of the audio streaming. For example, if the remote mute command and the remote un-mute command are transmitted through a separate channel, they may be transmitted through an ACL channel of separate channels.

For example, if the remote mute command and the remote un-mute command are transmitted through a separate channel, a channel used for the transmission and reception of a control message, such as the remote mute command, may be maintained and only a channel used for the transmission and reception of audio streaming may be removed because an audio data transmission and reception channel and a control message channel are separated and used.

The embodiment of FIG. 19 is characterized in that an audio sink device transmits a remote mute command and a remote un-mute command to an audio sink device in addition to an audio source device. That is, it may be seen that a remote mute command and a remote un-mute command may be transmitted and received between audio sink devices.

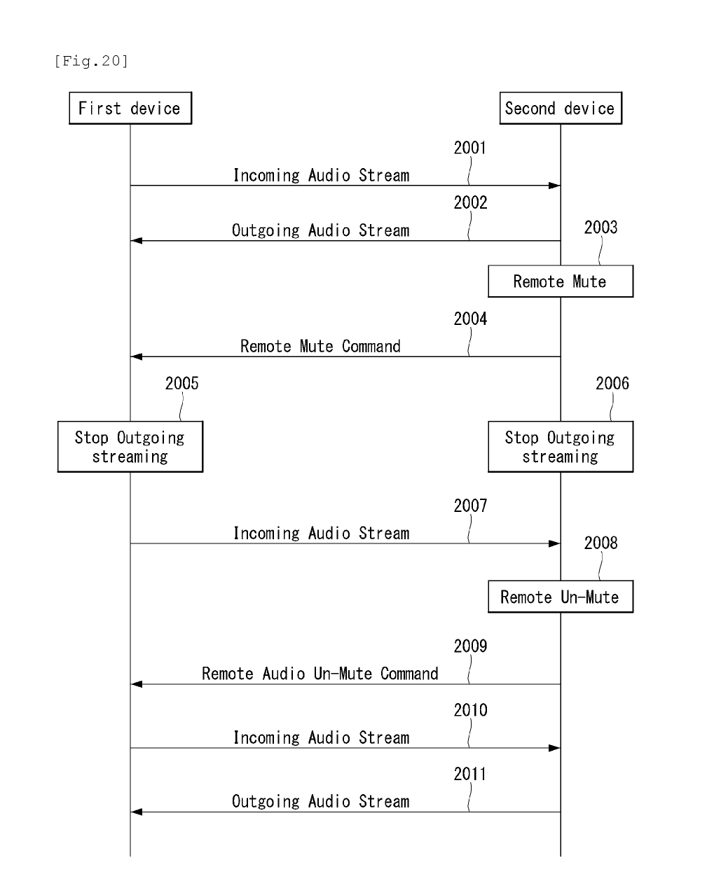

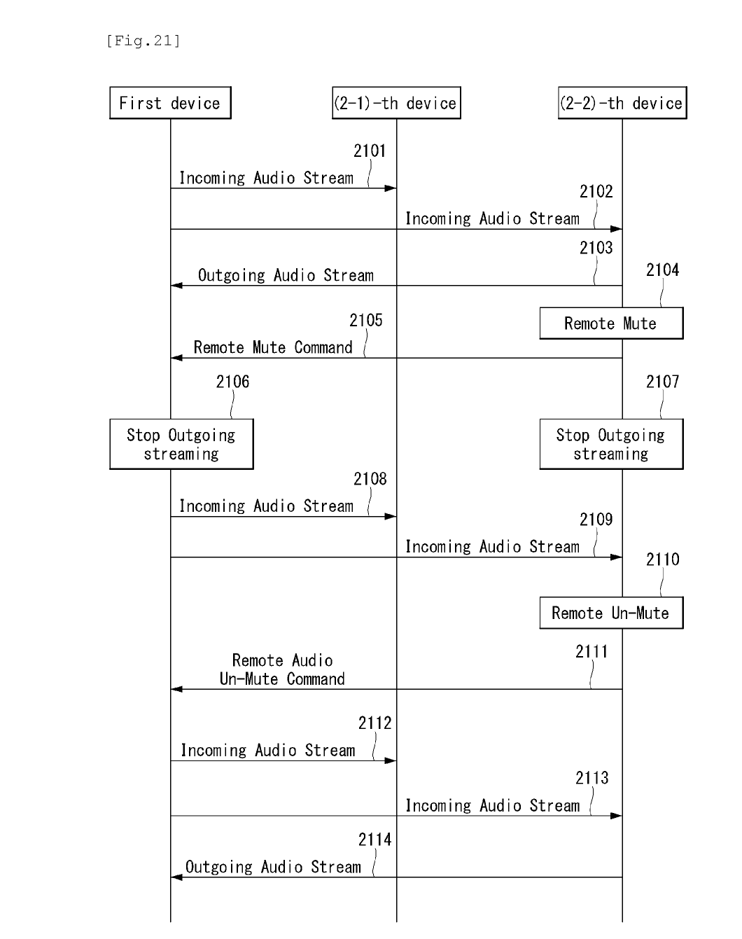

Embodiments in which audio streaming is transmitted or received have been described above. In this case, it may be seen that if a channel is removed, the transmission or reception of audio streaming is fully stopped. FIGS. 20 and 21 illustrate embodiments in which a channel used for the transmission of audio streaming and a channel used for the reception of audio streaming are separately present and only one of the two channels is removed when a remote mute is performed. Such embodiments are described below.

FIG. 20 is a diagram showing an example of a remote mute method and remote un-mute method of audio streaming in a bi-directional audio streaming environment according to an embodiment of the present invention.

A first device transmits audio streaming to a second device at step S2001. The audio streaming transmitted by the first device is hereinafter referred to as “incoming audio streaming”, for convenience of description.

The second device transmits audio streaming to the first device at step S2002. The audio streaming transmitted by the second device is hereinafter referred to as “outgoing audio streaming”, for convenience of description.

While the incoming audio streaming and the outgoing audio streaming are transmitted and received, when the second device receives a remote mute command from a user or receives a remote mute command from an external device connected to the second device in order to stop the transmission of the outgoing audio streaming, the second device executes a remote mute at step S2003.

When the remote mute is executed, the second device transmits a remote mute command to the first device at step S2004. The first device receives the remote mute command and removes a channel used for the reception of the outgoing audio streaming at step S2005. Accordingly, the reception of the outgoing audio data by the first device is stopped.

The second device transmits the remote mute command to the first device and removes a channel used for the transmission of the outgoing audio streaming at step S2006. Accordingly, the transmission of the outgoing audio data by the second device is stopped.

In this case, the transmission and reception of the incoming audio streaming is not stopped. Accordingly, the first device transmits the incoming audio streaming to the second device at step S2007.

While the transmission and reception of the outgoing audio streaming are stopped, when the second device receives a remote un-mute command from a user or receives a remote un-mute command from an external device connected to the second device, the second device executes a remote un-mute at step S2008.

When the remote un-mute is executed, the second device transmits a remote un-mute command to the first device at step S2009.

The first device transmits the incoming audio streaming to the second device regardless of the remote un-mute at step S2010.

The first device that has received the remote un-mute command sets up a channel to be used for the transmission and reception of the outgoing audio streaming with the second device that has transmitted the remote un-mute command and receives the outgoing audio streaming from the second device using the channel at step S2011.

Furthermore, the audio streaming may be transmitted through an isochronous channel for transmitting isochronous data. For example, in this case, the first device may set up an isochronous channel with the second device through the transmission or reception of a remote audio un-mute command.

Furthermore, the second device may transmit the remote mute command and the remote un-mute command to the first device through the same channel as a channel used for the transmission and reception of the audio streaming or may transmit them to the first device through a channel different from a channel used for the transmission and reception of the audio streaming. For example, if the remote mute command and the remote un-mute command are transmitted through a separate channel, they may be transmitted through an ACL channel of separate channels.

For example, if the remote mute command and the remote un-mute command are transmitted through a separate channel, a channel used for the transmission and reception of a control message, such as the remote mute command, may be maintained and only a channel used for the transmission and reception of audio streaming may be removed because a data transmission and reception channel and a control message channel are separated and used.

An example in which the first device is a smart phone and the second device is a headset is described below. When a remote mute is executed, the user of the headset may continue to receive data and listen to audio through the headset because incoming audio streaming is not stopped. In contrast, since outgoing audio streaming is stopped, the user of the headset may block the transmission of the audio streaming. Such an example may be used when only a user's voice is to be blocked.

Further to the aforementioned embodiment, an example in which the number of audio sink devices is two is described below. An example in which the number of audio sink devices is different is described, for convenience of description. It is however to be noted that the number of audio sink devices is not limited to 1 or 2 although the number of audio sink devices has been illustrated as being 1 or 2 in the embodiments. If the number of audio sink devices is 2, for example, it may correspond to an example in which a headset is separated into the left side and the right side and used.

FIG. 21 is a diagram showing another example of a remote mute method and remote un-mute method of audio streaming in a bi-directional audio streaming environment according to an embodiment of the present invention.

A first device transmits audio streaming to a (2-1)-th device at step S2101. Furthermore, the first device transmits audio streaming to a (2-2)-th device at step S2102. The audio streaming transmitted by the first device is hereinafter referred to as “incoming audio streaming”, for convenience of description.

The (2-2)-th device transmits audio streaming to the first device at step S2103. The audio streaming transmitted by the (2-2)-th device is hereinafter referred to as “outgoing audio streaming”, for convenience of description.

While the incoming audio streaming and the outgoing audio streaming are transmitted and received, when the (2-2)-th device receives a remote mute command from a user or receives a remote mute command from an external device connected to the (2-2)-th device in order to stop the transmission and reception of the outgoing audio streaming, the (2-2)-th device executes a remote mute at step S2104.

When the remote mute is executed, the (2-2)-th device transmits a remote mute command to the first device at step S2105. The first device receives the remote mute command and removes a channel used for the reception of the outgoing audio streaming at step S2106. Accordingly, the reception of the outgoing audio data by the first device is stopped.

The (2-2)-th device transmits the remote mute command to the first device and removes a channel used for the transmission of the outgoing audio streaming at step S2107. Accordingly, the transmission of the outgoing audio data by the (2-2)-th device is stopped.

In this case, the transmission and reception of the incoming audio streaming are not stopped. Accordingly, the first device transmits the incoming audio streaming to the (2-1)-th device at step S2108. Furthermore, the first device transmits the incoming audio streaming to the (2-2)-th device at step S2109.

While the transmission and reception of the outgoing audio streaming are stopped, when the (2-2)-th device receives a remote un-mute command from a user or receives a remote un-mute command from an external device connected to the (2-2)-th device, the (2-2)-th device executes a remote un-mute at step S2110.

When the remote un-mute is executed, the (2-2)-th device transmits a remote un-mute command to the first device at step S2111.

The first device transmits the incoming audio streaming to the (2-1)-th device regardless of the remote un-mute at step S2112. Furthermore, the first device transmits the incoming audio streaming to the (2-2)-th device at step S2113.

The first device that has received the remote un-mute command sets up a channel to be used for the transmission and reception of outgoing audio streaming with the (2-2)-th device that has transmitted the remote un-mute command and receives the outgoing audio streaming from the (2-2)-th device using the channel at step S2114.

Furthermore, the audio streaming may be transmitted through an isochronous channel for transmitting isochronous data. For example, in this case, the first device may set up an isochronous channel with the (2-2)-th device through the transmission or reception of a remote audio un-mute command.

Furthermore, the (2-2)-th device may transmit the remote mute command and the remote un-mute command to the first device through the same channel as a channel used for the transmission and reception of the audio streaming or may transmit them to the first device through a channel different from a channel used for the transmission and reception of the audio streaming. For example, if the remote mute command and the remote un-mute command are transmitted through a separate channel, they may be transmitted through an ACL channel of separate channels.

For example, if the remote mute command and the remote un-mute command are transmitted through a separate channel, a channel used for the transmission and reception of a control message, such as the remote mute command, may be maintained and only a channel used for the transmission and reception of audio streaming may be removed because a data transmission and reception channel and a control message channel are separated and used.

One of several embodiments of FIG. 21 is described below as an example. For example, an audio source device may be a smart phone, the (2-1)-th device may be a left headset, and the (2-2)-th device may be a right headset. An audio controller may have been embedded in the right headset, and a remote mute function may be used through the audio controller.

Referring to FIG. 21, A remote un-mute function may be used even if the number of audio sink devices is 2, and a remote mute command and a remote un-mute command may be transmitted and received between audio sink devices. If the number of audio sink devices is 2, for example, it may correspond to an example in which a headset is separated into the left side and the right side and used.

In this case, when a remote mute is executed, the user of the headset may continue to receive data and listen to audio through the headset because incoming audio streaming is not stopped. The user of the headset may block the transmission of audio streaming because outgoing audio streaming is stopped. Accordingly, such an example may be used when only a user's voice is to be blocked.

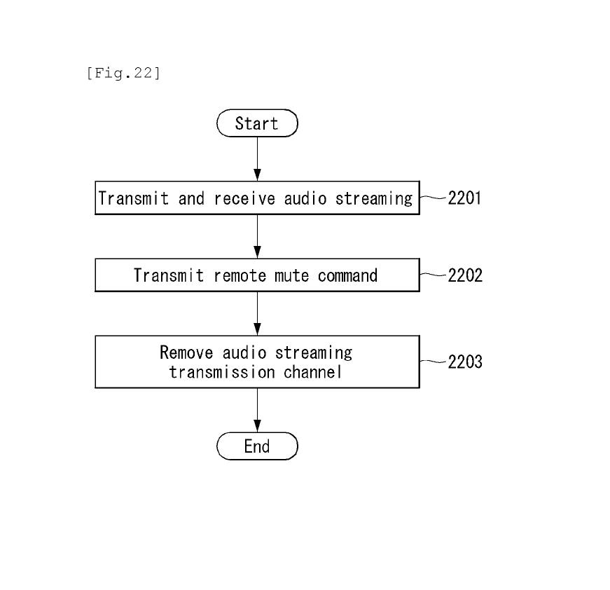

FIG. 22 is a flowchart illustrating an example of a remote mute method of audio streaming according to an embodiment of the present invention.

A first device transmits and receives audio streaming to and from a second device at step S2201. While the audio streaming is transmitted and received, the first device transmits a remote mute command for stopping the transmission of the audio stream to the second device at step S2202. The first device transmits the remote mute command and removes a channel used for the transmission of the audio stream at step S2203. The channel used for the transmission of the audio stream is removed, but a channel used for the reception of the audio stream is maintained.

As described above, in FIGS. 13, 15, and 16, the third device may be a remote controller fabricated to remotely control the audio source device and the audio sink device and may be part of the elements of a variety of types of portable devices, such as Hearing Aids (HA), a headset, an earphone, a PDA, and a smart phone. A remote controller, that is, an example of the third device which may be applied to an embodiment of the present invention is described below.

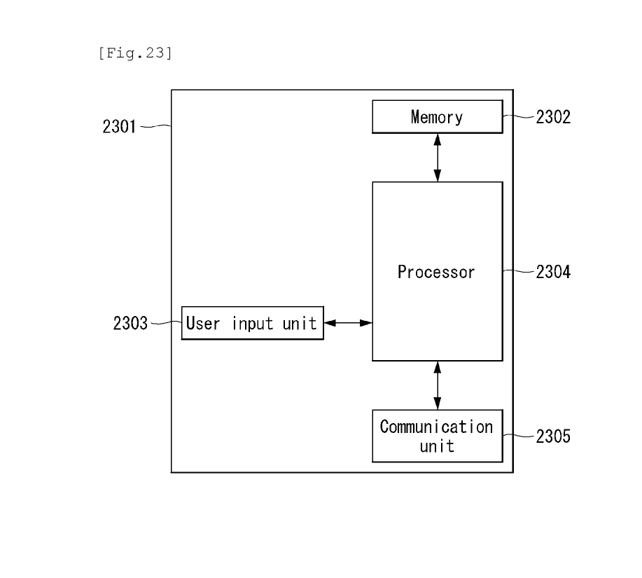

FIG. 23 is an example of a schematic block diagram of a remote controller capable of implementing methods proposed in this specification.

The internal block diagram of the remote controller may further include other elements (or modules, blocks, or units), and some of the elements of FIG. 23 may be omitted.

As shown in FIG. 23, the remote controller 2301 includes a user input unit (or a user input interface) 2303, a processor 2304, memory 2302, and a communication unit (or a transmission and reception unit) 2305.

The user input interface 2303, the processor 2304, the memory 2302, and the communication unit 2305 are operatively connected in order to perform a method proposed in this specification.

The memory 2302 is a unit implemented in a variety of types of devices and refers to a unit for storing a variety of types of data.

The processor 2304 refers to a module for controlling an overall operation of an audio source device or an audio sink device.

The processor 2304 may be represented as a control part, a control unit, or a controller.

The processor 2304 may include Application-Specific Integrated Circuits (ASICs), other chipsets, logic circuits and/or data processing units.

The memory 2302 may include Read-Only Memory

(ROM), Random Access Memory (RAM), flash memory, memory cards, storage media and/or other storage devices.

The communication unit 2305 may include baseband circuits for processing radio signals. When an embodiment is implemented by software, the aforementioned scheme may be implemented using a module (or process or function) for performing the aforementioned function. The module may be stored in the memory and executed by the processor.

The memory 2302 may be placed inside or outside the processor 2304 and may be connected to the processor 2304 by various well-known means.

The user input interface 2303 refers to a module for providing a user's input to the processor along with a screen button so that that the user may control the operation of a device. The user input interface 2303 may include a button, a keypad, a touch pad, or a touch screen.

The aforementioned embodiments are results in which the elements and characteristics of the present invention are combined in a specific form. Each of the elements or characteristics has to be considered to be optional unless otherwise described explicitly. Each of the elements or characteristics may be implemented in such a way as not to be combined with another element or characteristic. Furthermore, some of the elements and/or the characteristics may be combined to form an embodiment of the present invention. Order of the operations described in the embodiments of the present invention may be changed. Some of the elements or characteristics of one embodiment may be included in the other embodiment or may be replaced with corresponding elements or characteristics of the other embodiment. It is evident that in the claims, an embodiment may be formed by combining claims not having explicit citation relations or may be included as a new claim by amendments after the filing of this application.

An embodiment of the present invention may be implemented by various means, for example, hardware, firmware, software or a combination of them. In the case of implementations by hardware, an embodiment of the present invention may be implemented using one or more Application-Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers and/or microprocessors.

In the case of an implementation by firmware or software, an embodiment of the present invention may be implemented in the form of a module, procedure, or function for performing the aforementioned functions or operations. Software code may be stored in memory and driven by a processor. The memory may be placed inside or outside the processor, and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

In accordance with an embodiment of the present invention, energy efficiency can be improved because a remote mute command is delivered and the transmission and reception sides stop an operation related to audio streaming.

Furthermore, in accordance with an embodiment of the present invention, efficiency can be improved in terms of the operation of a frequency, that is, a radio resource, because a channel used for the transmission and reception of audio streaming is removed and only a channel used for the transmission and reception of a control message is maintained.

Furthermore, in accordance with an embodiment of the present invention, a remote mute can be controlled in real time and user convenience can be improved because a remote controller is used.

The technical advantages of the present invention are not limited to the aforementioned advantages and other technical advantages that have not been described will be evidently understood by those skilled in the art from the aforementioned description.

The aforementioned embodiments of the present invention have been disclosed for illustrative purposes, and those skilled in the art may improve, change, replace, or add various other embodiments without departing from the technical spirit and scope of the present invention disclosed in the attached claims.

What is claimed is:

1. A remote mute method for controlling a transmission and reception of audio streams in a wireless communication system supporting Bluetooth communication, the remote mute method comprising:
receiving, by a first device, an audio stream from a second device through an isochronous channel;
transmitting, by the first device, a remote mute command for stopping the transmission of the audio stream to the second device through an Asynchronous Connection Logical transport (ACL) channel; and
removing, by the first device, the isochronous channel.

2. The remote mute method of claim 1, further comprising:
transmitting, by the first device, a remote un-mute command for resuming the reception of the stopped audio stream to the second device; and
re-establishing, by the first device, the removed isochronous channel with the second device.

3. The remote mute method of claim 1, wherein the remote mute command is transmitted to the first device when the remote mute method is performed by the second device.

4. The remote mute method of claim 1, wherein the isochronous channel and the ACL channel are different channels.

5. The remote mute method of claim 3, further comprising transmitting, by the first device, information related to a call setup to the second device, wherein the remote mute method is performed based on the information related to the call setup.

6. The remote mute method of claim 5, wherein the remote mute method is performed when an in-band ring tone is not used.

7. A remote mute method for controlling a transmission and reception of audio streams in a wireless communication system supporting Bluetooth communication, the remote mute method comprising:
transmitting, by a first device, an audio stream to a second device through an isochronous channel;
receiving, by the first device, a remote mute command for stopping the reception of the audio stream from the second device or a third device through an Asynchronous Connection Logical transport (ACL) channel; and
removing, by the first device, the isochronous channel.

8. The remote mute method of claim 7, further comprising:
receiving, by the first device, a remote un-mute command for resuming the transmission of the stopped audio stream from the second device or the third device; and
re-establishing, by the first device, the removed isochronous channel with the second device.

9. The remote mute method of claim 7, wherein the isochronous channel and the ACL channel are different channels.

10. The remote mute method of claim 7, further comprising receiving, by the first device, information related to a call setup from the second device or the third device, wherein the remote mute method is performed based on the information related to the call setup.

11. The remote mute method of claim 10, wherein the remote mute is performed when an in-band ring tone is not used.

12. A remote mute method for controlling a transmission and reception of audio streams in a wireless communication system supporting Bluetooth communication, the remote mute method comprising:
transmitting and receiving, by a first device, audio streams to and from a second device through an isochronous channel;
transmitting, by the first device, a remote mute command for stopping the transmission of the audio stream to the second device through an Asynchronous Connection Logical transport (ACL) channel; and
removing, by the first device, the isochronous channel used for the transmission of the audio stream, wherein the isochronous channel used for the reception of the audio stream is maintained.

13. The remote mute method of claim 12, further comprising:
transmitting, by the first device, a remote un-mute command for resuming the transmission of the stopped audio stream to the second device; and
re-establishing, by the first device, the removed isochronous channel with the second device.

14. The remote mute method of claim 12, wherein the remote mute command is transmitted to the first device when the remote mute method is performed by the second device.

15. The remote mute method of claim 12, wherein the isochronous channel and the ACL channel are different channels.

16. The remote mute method of claim 12, further comprising transmitting, by the first device, information related to the call setup to the second device, wherein the remote mute method is performed based on the information related to the call setup.

17. The remote mute method of claim 16, wherein the remote mute method is performed when an in-band ring tone is not used.
